(19) United States
(12) Patent Application Publication
(10) Pub. No.: US 2010/0035171 A1
(43) Pub. Date: Feb. 11, 2010

(54) YELLOW TONER

(75) Inventors: Shuntaro Watanabe, Abiko-shi (JP); Yuji Moriki, Kawasaki-shi (JP); Ken-ichi Nakayama, Numazu-shi (JP); Koji Inaba, Hadano-shi (JP); Masayoshi Kato, Tokyo (JP); Masatake Tanaka, Yokohama-shi (JP); Takayuki Toyoda, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/484,506

(22) Filed: Jun. 15, 2009

Related U.S. Application Data
(63) Continuation of application No. PCT/JP2009/050123, filed on Jan. 8, 2009.

(30) Foreign Application Priority Data
Jan. 10, 2008 (JP) 2008-003231

(51) Int. Cl. G03G 9/09

(52) U.S. Cl. 430/108.23

(57) ABSTRACT

Provided is a yellow toner having toner particles each containing at least a binder resin, a colorant, and a polar resin, the yellow toner being characterized in that: the colorant is a coloring compound having a specific structure; in a microscopic compression test at a measurement temperature of 25° C., the toner has a recovery ratio Z(25) of 40 to 80%; and the toner has a glass transition temperature (TgA) measured with a differential scanning calorimeter (DSC) of 40° C. to 60° C. and a temperature (P1) of the highest endothermic peak measured with the DSC of 70° C. to 90° C., and the temperature (P1) of the highest endothermic peak and the glass transition temperature (TgA) satisfy the relationship of 15° C.≦P1−TgA≦50° C.

### BACKGROUND OF THE INVENTION

1. Field of the Invention

The present invention relates to a yellow toner to be used in an electrophotographic method, an electrostatic recording method, an electrostatic printing method, or a toner jet recording method.

2. Description of the Related Art

A known method of forming a visible image with toner is, for example, an electrophotographic method, an electrostatic recording method, an electrostatic printing method, or a toner jet recording method. For example, the electrophotographic method generally involves: forming an electrostatic latent image on a photosensitive member including a photoconductive material by various means; developing the latent image with toner; transferring the resultant toner image onto a recording material (transfer material) such as paper; and fixing the toner image on the recording material with heat or pressure to provide a print or copied article.

With the advent of developed computers and developed multimedia, means for outputting a full-color image having additionally high definition has been recently demanded in a wide variety of fields ranging from offices to households. An image-forming apparatus based on an electrophotographic method has recently become able to represent full colors and to store information about an image to be formed as a digital signal, so the apparatus has started to be used in: an environment where a professional image-forming technique is needed such as a design studio; and a color copying machine for paperwork. Further, the apparatus has started to be used in a printer as an output for a computer or in a personal printer for private use. Heavy users require such high durability that image quality does not reduce even after copying or printing on a large number of sheets. In contrast, in a small office or household, from the viewpoints of space savings and energy savings, the following properties have been demanded while the acquisition of a high-quality image is attained: for example, a reduction in size of an apparatus, the recycling of waste toner or the prevention of the production of waste toner (the removal of a cleaner), a reduction in fixation temperature, and image gloss for corresponding to photographic image quality.

Various methods are each available as a method of producing toner particles. For example, a pulverized toner produced by a pulverization method and a polymerized toner produced by a suspension polymerization method or emulsion agglomeration method are known toners produced by some of the above methods. The pulverization method is a method involving: melting and kneading a mixture containing, for example, a binder resin, a colorant, and a charge control agent with an apparatus capable of mixing under heat such as a heat kneader or a twin roll; cooling the resultant after the melting and kneading to solidify the resultant; pulverizing the solidified product with a mechanical or air collision-type pulverizer such as a ball mill or a jet mill; and classifying the pulverized products to provide toner particles each having a desired particle diameter.

The suspension polymerization method is a method involving: loading, into an aqueous phase containing a suspension stabilizer, a monomer composition prepared by uniformly dissolving or dispersing a polymerizable monomer, a colorant, a charge control agent, a polymerization initiator, and any other additive; subjecting the resultant to suspension polymerization; separating the solid content by filtration; and drying the separated product to provide toner particles each having a desired particle diameter.

An emulsion polymerization method is a method involving: suspending a monomer to perform emulsion polymerization in a liquid to which an emulsion of a needed additive has been added to produce resin fine particles; adding an organic solvent, an agglomerating agent, and the like to the particles to associate the particles; separating the resultant particles by filtration; and drying the separated particles to provide toner particles each having a desired particle diameter.

The suspension polymerization method or the like involving granulation in water rather than a toner production method based on the pulverization method has been further expected to satisfy the above-mentioned needs because of its ease with which the functions of toner materials are separated.

The viscoelasticity and melt viscosity of toner are important from the viewpoint of compatibility between the developing durability and fixing performance of the polymerized toner. Since toner generally receives a mechanical frictional force in a developing assembly to deteriorate, an improvement in viscoelasticity or melt viscosity of the toner is advantageous for the suppression of the deterioration. However, the viscoelasticity or melt viscosity of the toner must be lowered in order that low-temperature fixation or image gloss may be realized by curtailing an energy consumption in a fixing step. This not only provides obstacles to developing property and transferring property but also reduces the storage stability of the toner in an environment having a temperature around 50° C. On the other hand, a wax component in each particle of the toner preferably bleeds as instantaneously as possible in the fixing step because the releasing performance of the toner from a fixing roller becomes favorable. Investigations have been conducted on an approach to achieving compatibility between the developing durability and fixing performance, which are mutually contradictory as described above.

Some attempts to achieve compatibility between developing durability and fixing performance are each based on attention paid on the DSC curve of toner in a differential scanning calorimeter (DSC). A toner containing at least a binder resin and a colorant and having the following characteristic has been proposed (Patent Document 1): at least one peak is present near the glass transition point of the binder resin in a second temperature increase process of the DSC curve measured with a differential scanning calorimeter. Although the fixing performance of the toner can be improved by the approach, the approach generally requires a further improvement in consideration of durability and developing property at temperatures around room temperature.

On the other hand, when one achieves compatibility between the durability and fixing performance of toner while taking the internal structure of each particle of the toner into consideration, the durability and fixing performance of any one particle of the toner must be discussed, and the hardness (microscopic compression hardness) of any one particle of the toner can be an effective indicator: the hardness (microscopic compression hardness) of each particle of the toner represents the extent to which the toner particle deforms (elastically or plastically). Therefore, the microscopic compression hardness of the toner can be an effective indicator of transferring performance as well as the durability and the fixing performance in a transferring step where a toner particle may deform owing to a pressure applied by contact transfer or the like.

For example, the following has been disclosed (Patent Documents 2 and 3): in a capsule (core-shell structure) toner constituted of a thermofusible core (core) formed of a thermoplastic resin having a low glass transition point and an outer shell (shell) mainly formed of amorphous polyester, a relationship between a displacement by which one particle of the toner is compressed upon application of a load to the particle and the load is specified in a specific range, whereby compatibility among low-temperature fixability, offset resistance, and durability can be achieved. The capsule toner is effective in a heat-pressure fixing step because the toner is of such a structure that the core having a low glass transition point is coated with a relatively thick shell layer. However, the capsule toner has difficulty in satisfying low-temperature fixability and high image gloss in a light-load fixing step.

In addition, a certain hardness can be imparted to each particle of a toner obtained by an emulsion agglomeration method including the step of subjecting binder resin particles in each of which a high-molecular-weight body and a low-molecular-weight body coexist and colorant particles to salting out/melt adhesion. Accordingly, the toner maintains its good durability even in a non-magnetic, one-component developing system (Patent Document 4).

However, the storage stability and hot offset resistance of the toner obtained by the emulsion agglomeration method may gradually reduce because the structure of the resin particle is controlled so that the molecular weight of the resin of which each layer is constituted may reduce from the central portion of the particle to the surface layer of the particle.

Further, it has been proposed that, when a toner having the following characteristics is used, the toner easily splits in a fixing step, but is excellent in durability in a developing device and provides stable charging property (Patent Document 5): a load-displacement curve obtained by subjecting the particles of the toner to a microscopic compression test has a point of inflection, and the load at the point of inflection is larger than a load which the toner receives in a developing assembly.

Although the toner can satisfy fixing performance in the fixing step, the toner cannot satisfy low-temperature fixability under the conditions of the reduction of the load or an increase in speed in the fixing step, and, furthermore, the toner tends to have difficulty in obtaining high image gloss.

As described above, a large number of investigations referring to the internal structure of a toner particle for satisfying compatibility between its durability and fixing performance have been conducted. However, in today's circumstances where an additional increase in speed and a full-color image having additionally high definition are requested, such investigations are still insufficient, and a toner capable of sufficiently satisfying high durability, high transferring performance, and, furthermore, storage stability while maintaining good fixing performance and high image gloss has been demanded.

In addition, in the field of a yellow toner obtained by a polymerization method, the development of a colorant having the following characteristics has been demanded: the colorant has good color reproducibility, and is excellent in storage stability under any environment where the colorant is used and durability in development. In particular, when a toner is produced by a polymerization method, a colorant having high solubility in an organic solvent (a polymerizable monomer such as styrene is included in the category of the “organic solvent”) has been demanded in order that toner particles having uniform composition may be obtained. Further, an additive such as a colorant may inhibit polymerization in a toner produced by any one of the various polymerization methods, so it is important that the colorant do not cause polymerization inhibition. Conventionally disclosed colorants for yellow toners are monoazo-based pigments (Patent Documents 6 and 7) and polyazo-based pigments (Patent Documents 8 and 9). Although each of those pigments has good light fastness, each of the pigments has insufficient solubility in an organic solvent and an insufficient color tone.

Meanwhile, toners each having the following characteristic have been disclosed (Patent Documents 10 and 11): each of the toners uses a pyridone azo-based dye typified by C.I. Solvent Yellow 162 as a coloring dye for a yellow toner with a view to improving solubility in an organic solvent and a color tone. A pyridone azo-based dye having high solubility in an organic solvent has also been disclosed (Patent Document 12).

It has been proposed that any one of the dyes each having high coloring power be used for achieving high image quality. A coloring compound containing a functional group having high hydrophilicity such as a carboxyl group, a hydroxyl group, or a sulfonic group is included in the dyes. When any such dye is used in a toner produced by a polymerization method, the dye tends to be eluted in an aqueous medium, so the dye may precipitate on the surface of each toner particle. Accordingly, contrivance must be made to the utilization of a dye when toner particles are produced by granulation in an aqueous medium (Patent Document 13).

In the production of a toner by an emulsion polymerization method, the following procedure is credited with being desirable (Patent Document 14): toner materials are stirred with the pH of a coloring particle-containing liquid (coloring particle-dispersed liquid) at the time of a heating step intended for agglomeration/association adjusted to fall within the range of 7 to 12.

Further, there has also been proposed a polymerized toner which: is produced by suspension polymerization after the adjustment of the pH of a dispersion stabilizer-containing aqueous dispersion medium to 5.5 to 8.5; has good durability under high humidity and low humidity; favorably prevents the contamination of a charging member; and can provide a high-quality image (Patent Document 15). Although toner production in accordance with any one of the above proposals can suppress the exudation of a dye to the surface of each coloring particle, the production is still susceptible to improvement in terms of the suppression of the contamination of a control member, photosensitive member, or the like with the dye when an additional increase in speed of an image-forming apparatus is taken into consideration. In view of the foregoing, the development of a yellow toner having the following characteristics has been requested: the yellow toner contains a colorant which not only provides a good color tone but also has excellent light fastness, and the yellow toner achieves compatibility between good developing durability and fixing performance.

[Patent Document 1] JP 2004-184561 A

[Patent Document 2] JP 03003018 B

[Patent Document 3] JP 03391931 B

[Patent Document 4] JP 2004-109601 A

[Patent Document 5] JP 2005-300937 A

[Patent Document 6] JP 2000-35696 A

[Patent Document 7] JP 2003-149859 A

[Patent Document 8] JP 2001-166540 A

[Patent Document 9] JP 2004-234033 A

[Patent Document 10] JP 07-140716 A

[Patent Document 11] JP 03-42676 A

[Patent Document 12] JP 03-185074 A

[Patent Document 13] JP 06-222616 A

[Patent Document 14] JP 10-319624 A

[Patent Document 15] JP 03372805 B

### SUMMARY OF THE INVENTION

An object of the present invention is to provide a yellow toner that has achieved compatibility between good developing performance and excellent fixing performance.

The above problems will be solved by the following present invention.

The first invention relates to a yellow toner including toner particles each containing at least a binder resin, a colorant, and a polar resin, the yellow toner being characterized in that:

the colorant includes a coloring compound having a structure represented by the following formula (1):

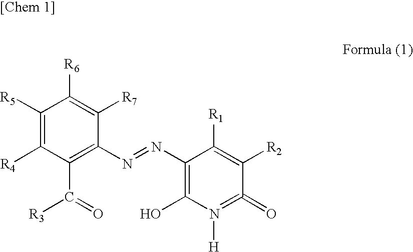

where R1 represents an alkyl group or an aryl group, R2 represents a hydrogen atom, a cyano group, or —CONH2, R3 represents an alkyloxy group, an alkenyloxy group, an aryloxy group, an aralkyloxy group, or —NR8R9 where R8 and R9 each independently represent a hydrogen atom, an alkyl group, an aryl group, an alkenyl group, or an aralkyl group, and —NR8R9 may form a heterocyclic ring, and R4, R5, R6, and R7 each independently represent a hydrogen atom, a halogen atom, —CF3, —NO2, an alkyl group, or an alkyloxy group;

in a case where, in a microscopic compression test on the toner at a measurement temperature of 25° C., a displacement (μm) at a time point when one particle of the toner is left to stand for 0.1 second after completion of application of a maximum load of 2.94×10−4 N to the particle at a loading rate of 9.8×10−5 N/sec is defined as a maximum displacement X3(25), and a displacement (μm) at a time point when the load is unloaded at an unloading rate of 9.8×10−5 N/sec to reach 0 N after the standing for 0.1 second is defined as a displacement X4(25), a recovery ratio Z(25) (%) [={(X3(25)−X4(25))/X3(25)}×100] as a percentage of an elastic displacement (X3(25)−X4(25)) as a difference between the maximum displacement X3(25) and the displacement X4(25) to the maximum displacement X3(25) satisfies a relationship of 40≦Z(25)≦80; and

the toner has a glass transition temperature (TgA) measured with a differential scanning calorimeter (DSC) of 40° C. to 60° C. and a temperature (P1) of a highest endothermic peak measured with the DSC of 70° C. to 90° C., and the temperature (P1) of the highest endothermic peak and the glass transition temperature (TgA) satisfy a relationship of 15° C.≦P1−TgA≦50° C.

According to a preferred embodiment of the present invention, there is provided a yellow toner that has achieved compatibility between good developing performance and excellent fixing performance.

Further features of the present invention will become apparent from the following description of exemplary embodiments (with reference to the attached drawings).

### BRIEF DESCRIPTION OF THE DRAWINGS

FIG. 1 is a sectional view of an electrophotographic apparatus.

FIG. 2 is an enlarged view of a developing portion of the electrophotographic apparatus.

FIG. 3 is a load-displacement curve in a microscopic compression test on toner.

FIG. 4 is a view showing the 1H-NMR spectrum of a coloring compound D1 in chloroform-d at room temperature and 400 MHz.

### DESCRIPTION OF SYMBOLS

10: latent image bearing member (photosensitive drum)
11: charging member contacting latent image bearing member
12: power supply
13: developing unit
14: toner carrying member
15: toner feeding roller
16: control member
17: non-magnetic toner
23: developer container
24: control member support plate
27: power supply
101a to d: photosensitive drum
102a to d: primary charging mean
103a to d: scanner
104a to d: developing portion
106a to d: cleaning mean
108b: sheet feeding roller
108c: resist roller
109a: electrostatic adsorption transport belt
109b: driver roller
109c: fixed roller
109d: tension roller
110: fixing unit
110c: discharge roller
113: discharge tray
S: recording medium

### DESCRIPTION OF THE EMBODIMENTS

First, a coloring compound having a structure represented by the following formula (1) to be incorporated as a colorant into a toner of the present invention will be described in detail.

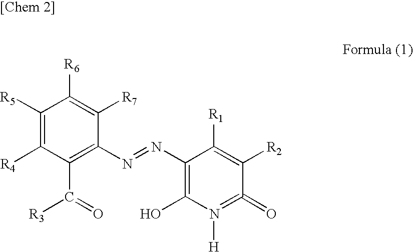

[In the formula, R1 represents an alkyl group or an aryl group, R2 represents a hydrogen atom, a cyano group, or —CONH2, R3 represents an alkyloxy group, an alkenyloxy group, an aryloxy group, an aralkyloxy group, or —NR8R9 where R8 and R9 each independently represent a hydrogen atom, an alkyl group, an aryl group, an alkenyl group, or an aralkyl group, and —NR8R9 may form a heterocyclic ring, and R4, R5, R6, and R7 each independently represent a hydrogen atom, a halogen atom, —CF3, —NO2, an alkyl group, or an alkyloxy group.]

The inventors of the present invention have made extensive studies with a view to solving the problems of the prior art. As a result, the inventors have found that a yellow toner that has achieved compatibility between good developing performance and excellent fixing performance is provided by the production of a toner which: uses a colorant containing a coloring compound having a structure represented by the above formula (1); and has the above characteristics. Thus, the inventors have reached the present invention.

R₁ in the above formula (1) represents an alkyl group or an aryl group and the following are exemplified: a methyl group, an ethyl group, an n-propyl group, an isopropyl group, an n-butyl group, a sec-butyl group, a tert-butyl group, a 2-ethylhexyl group, a phenyl group, and a naphthyl group. R₁ represents the above alkyl group or aryl group and may be further substituted with a substituent. As the substituent, a nonionic group such as an alkyl group, a halogen atom, —CF₃, and —NO₂ is preferred. In addition, R₁ particularly suitably represents a methyl group and a phenyl group.

R₂ in the above formula (1) represents a hydrogen atom, a cyano group, or —CONH₂, the cyano group is preferred from the viewpoints of light fastness and easiness of material availability.

R₃ in the above formula (1) represents an alkyloxy group, an alkenyloxy group, an aryloxy group, an aralkyloxy group, or —NR₈R₉.

The alkyloxy group represented by R₃ is not particularly limited and, for example, the following are exemplified: a methoxy group, an ethoxy group, an n-propoxy group, an iso-propoxy group, an n-butoxy group, a sec-butoxy group, a tert-butoxy group, an n-pentyloxy group, an iso-pentyloxy group, an n-hexyloxy group, an iso-hexyloxy group, a 2-ethylhexyloxy group, a 3,5,5-trimethylhexyloxy group, an n-heptyloxy group, an n-octyloxy group, an n-nonyloxy group, and a cyclohexyloxy group.

The alkenyloxy group represented by R3 is not particularly limited and the examples thereof include 2-propene-1-oxy group, a 3-butene-2-oxy group, a 1-pentene-3-oxy group, and a 3,7-dimethyl-6-octene-1-oxy group.

The aryloxy group represented by R3 is not particularly limited and, for example, the following are exemplified: a phenoxy group, a methylphenoxy group, a dimethylphenoxy group, a methoxy phenoxy group, a chlorophenoxy group, a bromophenoxy group, a fluorophenoxy group, a trifluoromethylphenoxy group, a naphthyloxy group, and 4-octylphenoxy group.

The aralkyloxy group represented by R3 is not particularly limited and examples thereof include a benzyloxy group and a diphenylmethoxy group.

R3 represents any one of an alkyloxy group, an alkenyloxy group, an aryloxy group, and an aralkyloxy group and may be further substituted with a substituent. As the substituent, a nonionic group such as an alkyl group, a halogen atom, —CF3, and —NO2 is preferred.

In addition, R3 may represent —NR8R9. The R8 and R9 each independently represent a hydrogen atom, an alkyl group, an aryl group, an alkenyl group, or an aralkyl group. In addition, R₈ and R₉ may be linked to form a heterocyclic ring in —NR₈R₉.

The alkyl group represented by R₈ and R₉ is not particularly limited and examples thereof include a methyl group, an ethyl group, an n-propyl group, an isopropyl group, an n-butyl group, a sec-butyl group, a tert-butyl group, an n-pentyl group, an n-hexyl group, a cyclohexyl group, an n-heptyl group, an n-octyl group, a 2-ethylhexyl group, an n-nonyl group, an n-decyl group, an n-undecyl group, and an n-dodecyl group.

Examples of the alkenyl group represented by R8 and R9 include a vinyl group, a 1-propenyl group, a 2-propenyl group, a 1-butenyl group, a 2-butenyl group, a 3-butenyl group, a 1-cyclohexenyl group, and a 2-cyclohexenyl group.

Examples of the aryl group represented by R8 and R9 include a phenyl group and a naphthyl group. Examples of the aralkyl group include a benzyl group and a phenethyl group.

In addition, R8 and R9 may form a heterocyclic ring with a nitrogen atom. Specific examples of the heterocyclic ring formed of R8, R9, and the nitrogen atom include a piperazine ring, a piperidine ring, a pyrrolidine ring, and a morpholin ring.

R8 and R9 each represent an alkyl group, an aryl group, an alkenyl group, and an aralkyl group, and may be substituted with a substituent. As the substituent that can be substituted, a nonionic group such as an alkyl group, a halogen atom, —CF₃, and —NO₂ is preferred.

R₃ preferably represents —NR₈R₉ from the viewpoint of easiness in synthesis. Further, R₈ and R₉ each independently preferably represent an alkyl group. Further, from the solubility to an organic solvent (including a polymerizable monomer such as styrene), the total number of the carbon atoms of the R₈ and R₉ is preferably 12 or more and preferably 24 or less from the viewpoint of easy production.

R₄, R₅, R₆, and R₇ in the above formula (1) each independently represent a hydrogen atom, a halogen atom, —CF3, —NO2, an alkyl group, or an alkoxy group.

Examples of the halogen atom represented by R4, R5, R6, and R7 include a fluorine atom, a chlorine atom, a bromine atom, and an iodine atom.

The alkyl group represented by R₄, R₅, R₆, and R₇ is not particularly limited and the following are exemplified: a methyl group, an ethyl group, an n-propyl group, an isopropyl group, an n-butyl group, a sec-butyl group, a tert-butyl group, and a 2-ethylhexyl group.

R₄, R₅, R₆, and R₇ may each represent an alkyloxy group and in this case, are not particularly limited. Examples thereof include a methoxy group, an ethoxy group, an n-propoxy group, an iso-propoxy group, an n-butoxy group, an iso-butoxy group, a tert-butoxy group, an n-pentyloxy group, an iso-pentyloxy group, an n-hexyloxy group, an iso-hexyloxy group, a 2-ethylhexyloxy group, a 3,5,5-trimethylhexyloxy group, an n-heptyloxy group, an n-octyloxy group, an n-nonyloxy group, and a cyclohexyloxy group.

R₄, R₅, R₆, and R₇ described above each represent any such alkyl or alkyloxy group as described above; the alkyl or alkyloxy group may be further substituted with a substituent. The substituent is preferably a nonionic group such as an alkyl group, a halogen atom, —CF₃, or —NO₂.

R₄, R₅, R₆, and R₇ each suitably represent a hydrogen atom in terms of the ease of availability of a raw material and light fastness.

The coloring compound having a structure represented by the above formula (1) whose substituents have each been described above is more preferably a coloring compound having a structure represented by the following formula (2).

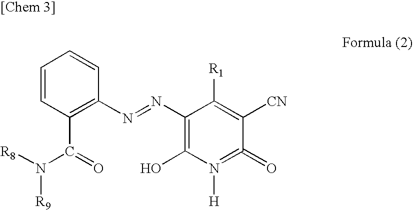

[In the formula, R1 represents a methyl group or a phenyl group, R8 and R9 each independently represent an alkyl group, or R8 and R9 represent a heterocyclic ring formed with a nitrogen atom, and the total number of carbon atoms of R₈ and R₉ is 12 or more and 24 or less.]

The coloring compound having a structure represented by the above formula (1) or (2) can be synthesized by a known method. For example, diazo coupling between a diazo component having a structure represented by the following formula (3) and a pyridone compound having a structure represented by the following formula (4) suffices for the synthesis. To be specific, first, an aqueous solution of sodium nitrite is added to the diazo component having a structure represented by the following formula (3) in hydrochloric acid to diazotize the component. After the diazotization, the resultant is subjected to a coupling reaction with the pyridone compound having a structure represented by the following formula (4). Further, the reaction product is purified by a recrystallization method or column chromatography as required. Thus, the coloring compound having a structure represented by the above formula (1) or (2) can be obtained at a desired purity.

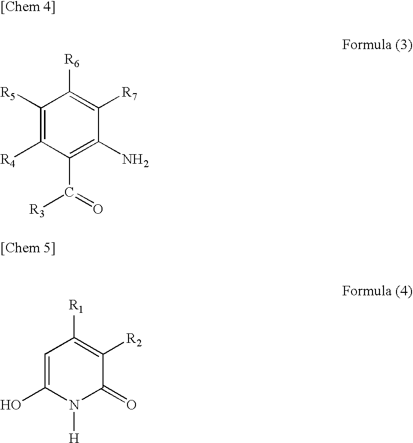

Next, a yellow toner (which may hereinafter be simply referred to as “toner”) of the present invention will be described.

The yellow toner of the present invention is a yellow toner having toner particles each containing at least a binder resin, a colorant, and a polar resin, and one of its characteristics is as follows: the colorant is a coloring compound having a structure represented by the above formula (1).

A method of producing the above toner particles, which is not particularly limited, is, for example, a pulverization method, a suspension polymerization method, or an emulsion polymerization method. The coloring compound having a structure represented by the above formula (1) which does not cause polymerization inhibition is suitably used particularly in a method involving a polymerization reaction in a production process for the toner particles such as the suspension polymerization method or the emulsion polymerization method.

The colorant to be used in the toner of the present invention is selected in terms of a hue angle, chroma, brightness, light fastness, OHP transparency, and dispersing performance in the toner. The colorant is preferably added and used in an amount of 1 part by mass to 20 parts by mass with respect to 100 parts by mass of the binder resin. In addition, the content of the coloring compound having a structure represented by the above formula (1) is preferably 0.5 part by mass to 10 parts by mass with respect to 100 parts by mass of the binder resin.

The toner of the present invention preferably contains a yellow pigment as another colorant as well as the coloring compound having a structure represented by the above formula (1).

Examples of the above yellow pigment include a monoazo-based pigment, a disazo-based pigment, and a polyazo-based pigment.

Specific examples include the following. C.I. Pigment Yellow 12, C.I. Pigment Yellow 13, C.I. Pigment Yellow 14, C.I. Pigment Yellow 15, C.I. Pigment Yellow 17, C.I. Pigment Yellow 62, C.I. Pigment Yellow 74, C.I. Pigment Yellow 83, C.I. Pigment Yellow 93, C.I. Pigment Yellow 94, C.I. Pigment Yellow 95, C.I. Pigment Yellow 97, C.I. Pigment Yellow 109, C.I. Pigment Yellow 110, C.I. Pigment Yellow 111, C.I. Pigment Yellow 120, C.I. Pigment Yellow 127, C.I. Pigment Yellow 128, C.I. Pigment Yellow 129, C.I. Pigment Yellow 147, C.I. Pigment Yellow 151, C.I. Pigment Yellow 154, C.I. Pigment Yellow 155, C.I. Pigment Yellow 168, C.I. Pigment Yellow 174, C.I. Pigment Yellow 175, C.I. Pigment Yellow 176, C.I. Pigment Yellow 180, C.I. Pigment Yellow 181, C.I. Pigment Yellow 185, C.I. Pigment Yellow 191, and C.I. Pigment Yellow 194.

Of those, preferred are C.I. Pigment Yellow 74, C.I. Pigment Yellow 93, C.I. Pigment Yellow 128, and C.I. Pigment Yellow 155.

Each of those yellow pigments can be used alone, or two or more of them can be used as a mixture, and, furthermore, each of them can be used in a solid solution state. In addition, the content of the above yellow pigment is preferably 1 part by mass to 20 parts by mass with respect to 100 parts by mass of the binder resin.

Examples of the binder resin to be used in the yellow toner of the present invention include a commonly-used styrene-acrylic copolymer, styrene-methacrylic copolymer, epoxy resin, and styrene-butadiene copolymer. A vinyl-based polymerizable monomer capable of radical polymerization can be used as the polymerizable monomer in the production of the above binder resin. A monofunctional polymerizable monomer or polyfunctional polymerizable monomer can be used as the polymerizable monomer vinyl-based polymerizable monomer.

As the polymerizable monomer to be used in the production of the above binder resin, the following are exemplified. Styrene; styrene-based monomers such as o- (m-, p-)methylstyrene and m- (p-)ethylstyrene; acrylate-based monomers or methacylate-based monomers such as methyl acrylate, methyl methacrylate, ethyl acrylate, ethyl methacrylate, propyl acrylate, propyl methacrylate, butyl acrylate, butyl methacrylate, octyl actyalte, octyl methacrylate, dodecyl acrylate, dodecyl methacrylate, stearyl acrylate, stearyl methacrylate, behenyl acrylate, behenyl methacrylate, 2-ethylhexyl acrylate, 2-ethylhexyl methacrylate, dimethylaminoethyl acrylate, dimethylaminoethyl methacrylate, diethylaminoethyl acrylate, and diethylaminoethyl methacrylate; ene-based monomers such as butadiene, isoprene, cyclohexene, acrylonitrile, methacrylonitrile, acrylic acid amide, and methacrylic acid amide.

Although each of those polymerizable monomers may be used alone, two or more of them are generally mixed in an appropriate fashion before use with reference to a theoretical glass transition temperature (Tg) described in the publication Polymer Handbook, 2nd edition, III, p 139 to 192 (published by John Wiley & Sons).

The yellow toner of the present invention has the following characteristic: in the case where, in the microscopic compression test on the toner at a measurement temperature of 25° C., a displacement (μm) at a time point when one particle of the toner is left to stand for 0.1 second after completion of application of a maximum load of 2.94×10⁻⁴ N to the particle at a loading rate of 9.8×10⁻⁵ N/sec is defined as a maximum displacement X₃₍₂₅₎, and a displacement (μm) at a time point when the load is unloaded at an unloading rate of 9.8×10⁻⁵ N/sec to reach 0 N after the standing for 0.1 second is defined as a displacement X₄₍₂₅₎, a recovery ratio [={(X₃₍₂₅₎−X₄₍₂₅₎)/X₃₍₂₅₎}×100] as a percentage of an elastic displacement (X₃₍₂₅₎−X₄₍₂₅₎) as a difference between the maximum displacement X₃₍₂₅₎ and the displacement X₄₍₂₅₎ to the maximum displacement X₃₍₂₅₎ is defined as Z(25) (%), satisfies the relationship of 40≦Z(25)≦80. Preferably, 40≦Z(25)≦70, and more preferably 40≦Z(25)≦60.

In addition, the yellow toner of the present invention has the following characteristic: in the case where, in the microscopic compression test on the toner at a measurement temperature of 50° C., a displacement (μm) at a time point when one particle of the toner is left to stand for 0.1 second after completion of application of a maximum load of 2.94×10⁻⁴ N to the particle at a loading rate of 9.8×10⁻⁵ N/sec is defined as a maximum displacement X₃₍₅₀₎, and a displacement (μm) at a time point when the load is unloaded at an unloading rate of 9.8×10⁻⁵ N/sec to reach 0 N after the standing for 0.1 second is defined as a displacement X₄₍₅₀₎, a recovery ratio [={(X₃₍₅₀₎−X₄₍₅₀₎)/X₃₍₅₀₎}×100] as a percentage of an elastic displacement (X₃₍₅₀₎−X₄₍₅₀₎) as a difference between the maximum displacement X₃₍₅₀₎ and the displacement X₄₍₅₀₎ to the maximum displacement X₃₍₅₀₎ is defined as Z(50) (%), satisfies the relationship of 10≦Z(50)≦35. Preferably, 15≦Z(50)≦35, and more preferably 20≦Z(50)≦30.

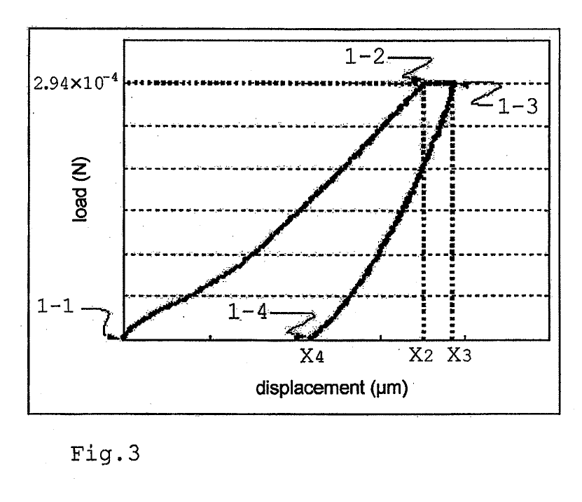

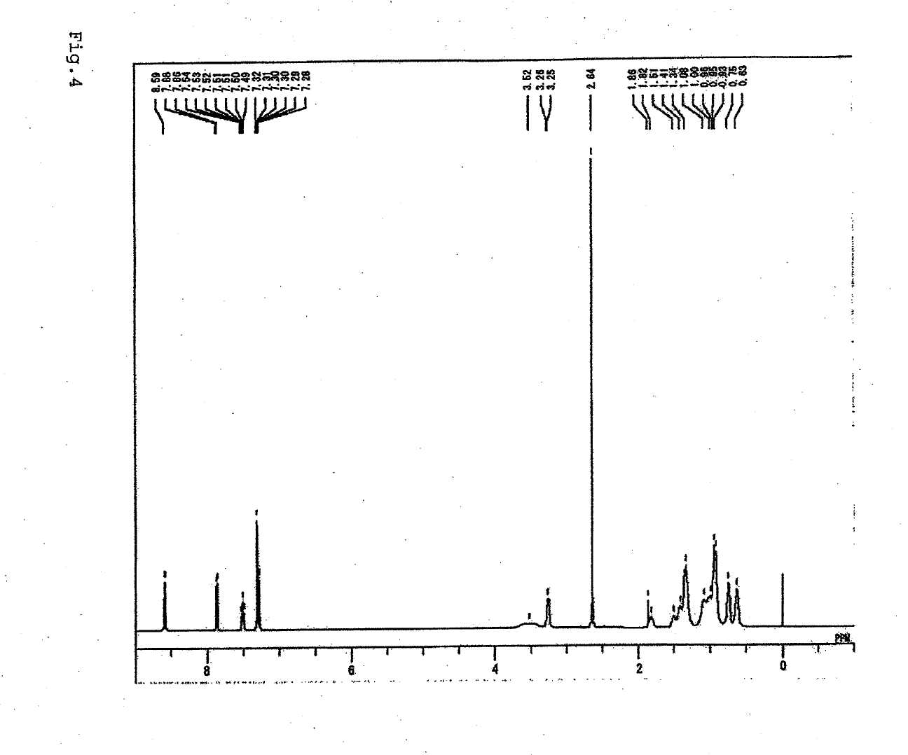

A measurement method for the microscopic compression test will be described with reference to FIG. 3.

FIG. 3 shows a profile (load-displacement curve) upon measurement for the yellow toner of the present invention by the microscopic compression test. The axis of abscissa indicates the displacement by which the toner deforms, and the axis of ordinate indicates a load applied to the toner.

An ultra-micro hardness meter ENT1100 manufactured by ELIONIX CO., LTD. was used in the microscopic compression test in the present invention. A flat indenter measuring 20 μm by 20 μm was used as an indenter in the measurement. 1-1 represents an initial state before the initiation of the test. A load is applied at a loading rate of 9.8×10⁻⁵ N/sec to reach a maximum load of 2.94×10⁻⁴ N. After the load has reached the maximum load, a state 1-2 is established. A displacement in this state is represented by X₂ (μm). The toner is left to stand in the state 1-2 for 0.1 second at the load. 1-3 represents a state immediately after the completion of the standing, and a maximum displacement in the state is represented by X₃ (μm). Further, the load is reduced from the maximum load at an unloading rate of 9.8×10⁻⁵ N/sec, and the time point at which the load reaches 0 N corresponds to a state 1-4. A displacement in this state is represented by X₄ (μm).

Z(25) described above (which may hereinafter be referred to as “recovery ratio Z(25)”) was determined as a recovery ratio [={(X₃−X₄)/X₃}×100] as a percentage of an elastic displacement (X₃−X₄) as a difference between the maximum displacement X₃ and the displacement X₄ to the maximum displacement X₃. Further, a value for Z(50) (which may hereinafter be referred to as “recovery ratio Z(50)”) is a value measured in the same manner as in the method of measuring Z(25) described above except that the measurement is performed at a temperature of 50° C. as described above.

In actuality, the measurement is performed as follows: the toner is applied onto a ceramic cell, weak air is blown so that the toner may be dispersed onto the cell, and then the cell is set in the meter.

In addition, upon measurement, the cell was brought into such a state that the temperature of the cell could be controlled, and the temperature of the cell was defined as a measurement temperature. That is, Z(25) was measured by setting the temperature of the cell to 25° C., and Z(50) was measured by setting the temperature of the cell to 50° C. In the microscopic compression test of the present invention, the toner is dispersed on the cell, and then the cell was placed in the meter. After that, the cell was left to stand for 10 minutes or longer after its temperature had reached the measurement temperature, and then the measurement was initiated.

The measurement was performed as follows: a toner present as one particle in a screen for measurement (breadth: 160 μm, length: 120 μm) was selected with a microscope included with the meter. A toner particle having a particle diameter in the range of the number average particle diameter d1 of the toner±0.2 μm was selected for the measurement in order that an error about a displacement might be eliminated to the extent possible. An arbitrary toner may be selected from the screen for measurement as long as the toner satisfies the above relationship. The particle diameter of a toner on the screen for measurement was measured by the following method: software included with the ultra-micro hardness meter ENT 1100 was used for measuring the longer diameter and shorter diameter of a toner particle, and a toner having an aspect ratio [(longer diameter+shorter diameter)/2] determined from the diameters in the range of d1±0.2 μm was selected for the measurement.

Measurement data was processed as described below. 100 arbitrary particles were selected for the measurement so that 100 values were determined for each of Z(25) and Z(50). Ten highest values and ten lowest values were eliminated from the 100 values for each of Z(25) and Z(50), and the remaining 80 values were used as data. The arithmetic mean of the 80 values was determined and used as each of Z(25) and Z(50).

Further, the measurement method of the number average particle diameter (d1) of toner is as follows.

As the measuring apparatus, a precision particle size distribution measuring apparatus based on a pore electrical resistance method provided with a 100-μm aperture tube “Coulter Counter Multisizer 3” (registered trademark, manufactured by Beckman Coulter, Inc) is used. The dedicated software included with the apparatus “Beckman Coulter Multisizer 3 Version 3.51” (manufactured by Beckman Coulter, Inc) is used for setting measurement conditions and analyzing measurement data. It should be noted that the number of effective measurement channels is set to 25,000.

An electrolyte solution prepared by dissolving reagent grade sodium chloride in ion-exchanged water to have a concentration of about 1 mass %, for example, an “ISOTON II” (manufactured by Beckman Coulter, Inc) can be used in the measurement.

It should be noted that the dedicated software was set as described below prior to the measurement and the analysis.

In the “change of standard measurement method (SOM)” screen of the dedicated software, the total count number of a control mode is set to 50,000 particles, the number of times of measurement is set to 1, and a value obtained by using “standard particles each having a particle diameter of 10.0 μm” (manufactured by Beckman Coulter, Inc) is set as a Kd value. A threshold and a noise level are automatically set by pressing a “threshold/noise level measurement” button. In addition, a current is set to 1,600 μA, a gain is set to 2, and an electrolyte solution is set to an ISOTON II, and a check mark is placed in a check box as to whether the aperture tube is flushed after the measurement.

In the “setting for conversion from pulse to particle diameter” screen of the dedicated software, a bin interval is set to a logarithmic particle diameter, the number of particle diameter bins is set to 256, and a particle diameter range is set to the range of 2 μm to 60 μm.

A specific measurement method is as described below.

(1) About 200 ml of the electrolyte solution are charged into a 250-ml round-bottom beaker made of glass dedicated for the Multisizer 3. The beaker is set in a sample stand, and the electrolyte solution in the beaker is stirred with a stirrer rod at 24 rotations/sec in a counterclockwise direction. Then, dirt and bubbles in the aperture tube are removed by the “aperture flush” function of the dedicated software.

(2) About 30 ml of the electrolyte solution are charged into a 100-ml flat-bottom beaker made of glass. About 0.3 ml of a diluted solution prepared by diluting a “Contaminon N” (a 10-mass % aqueous solution of a neutral detergent for washing a precision measuring device formed of a nonionic surfactant, an anionic surfactant, and an organic builder and having a pH of 7, manufactured by Wako Pure Chemical Industries, Ltd.) with ion-exchanged water by about three mass-fold is added as a dispersant to the electrolyte solution.

(3) An ultrasonic dispersing unit “Ultrasonic Dispension System Tetra 150” (manufactured by Nikkaki Bios Co., Ltd.) in which two oscillators each having an oscillatory frequency of 50 kHz are built so as to be out of phase by 180° and which has an electrical output of 120 W is prepared. A predetermined amount of ion-exchanged water is charged into the water tank of the ultrasonic dispersing unit. About 2 ml of the Contaminon N are charged into the water tank.

(4) The beaker in the section (2) is set in the beaker fixing hole of the ultrasonic dispersing unit, and the ultrasonic dispersing unit is operated. Then, the height position of the beaker is adjusted in order that the liquid level of the electrolyte solution in the beaker may resonate with an ultrasonic wave from the ultrasonic dispersing unit to the fullest extent possible.

(5) About 10 mg of toner are gradually added to and dispersed in the electrolyte solution in the beaker in the section (4) in a state where the electrolyte solution is irradiated with the ultrasonic wave. Then, the ultrasonic dispersion treatment is continued for an additional 60 seconds. It should be noted that the temperature of water in the water tank is appropriately adjusted so as to be 10° C. or higher and 40° C. or lower upon ultrasonic dispersion.

(6) The electrolyte solution in the section (5) in which the toner has been dispersed is dropped with a pipette to the round-bottom beaker in the section (1) placed in the sample stand, and the concentration of the toner to be measured is adjusted to about 5%. Then, measurement is performed until the particle diameters of 50,000 particles are measured.

(7) The measurement data is analyzed with the dedicated software included with the apparatus, and the number average particle diameter (d1) of the toner are calculated. It should be noted that an “average diameter” on the “analysis/number statistics (arithmetic average)” screen of the dedicated software when the dedicated software is set to show a graph in a number % unit is the number average particle diameter (d1).

The method for the microscopic compression test employed in the present invention involves applying a maximum load of 2.94×10⁻⁴ N to the toner. The method intends to measure a hardness and a recovery ratio near the surface of the toner by applying a small load as compared to that in a conventional measurement method.

Compatibility between the low-temperature fixability and durability of the toner can be realized by setting the value for the recovery ratio Z(25) within the range of the present invention in the above microscopic compression test on the toner. When the value for the recovery ratio Z(25) is set within the range of the present invention, each toner particle has a shell layer with an optimum hardness, so its durability is improved. At the same time, the core layer of the particle can be designed so as to be sufficiently soft, so improvements in, for example, low-temperature fixability and image gloss of the toner can be realized. In addition, a core-shell structure is formed in each toner particle, the adhesiveness between the core layer and the shell layer is high, and the particle shows high toughness to an external factor at the time of the pressurization of the toner at normal temperature. Accordingly, a core component (especially a wax) has bleeding performance at the time of the heating of the toner, so the storage stability of the toner is improved.

Further, the toner of the present invention hardly deforms owing to a stress to be applied to the toner in a developing assembly in the case where the value for the recovery ratio Z(25) of the toner is 40 or more. In addition, in this case, the hot offset resistance of the toner is improved.

Meanwhile, the bleeding performance of the wax does not reduce in a fixing step, cold offset hardly occurs, and the toner is excellent in low-temperature fixability in the case where the value for the recovery ratio Z(25) is less than 80. In addition, in this case, the image gloss of the toner is improved. In addition, in this case, the surface of each toner particle is not excessively hard, so the following tendency is observed: an external additive can easily adhere to the surface of each toner particle, the external additive on the toner surface is hardly liberated upon printing out on a large number of sheets, and the developing performance and transferring performance of the toner are improved.

In addition, when the value for the recovery ratio Z(50) at a measurement temperature of 50° C. of the toner of the present invention is set to 10 to 35, the deterioration of the toner due to friction between a toner carrying member and a toner control member at high temperatures and high humidities can be suppressed in an additionally favorable fashion.

The above recovery ratios Z(25) and Z(50) can be caused to satisfy the above relationships by employing, for example, the following approach. However, approaches for the above purpose are not limited to the following approach.

(1) In the case where the toner particles are produced in an aqueous medium, a polar resin to be described later is incorporated into each of the toner particles, and the shell layer is formed of the polar resin. In this case, the polar resin is selected in consideration of its compatibility with the binder resin of which the core layer is formed.

(2) After core particles have been produced in the aqueous medium, a monomer of which the polar resin is constituted is added to the particles, and the mixture is subjected to seed polymerization so that the shell layer may be formed.

(3) Polar resin fine particles having a smaller volume-average particle diameter than that of the core particles are mechanically caused to adhere to the core particles. Alternatively, the polar resin fine particles having a smaller volume-average particle diameter than that of the core particles are caused to adhere to the core particles in the aqueous medium, and then the fine particles are fixed to the core particles by a heating step.

In the present invention, even when the value for Z(25) satisfies the above-mentioned relationship, it is important that the following conditions be satisfied in order that good fixing performance may be achieved: the toner has a glass transition temperature (TgA) measured with a differential scanning calorimeter (DSC) of 40° C. to 60° C. and a temperature (P1) of the highest endothermic peak measured with the differential scanning calorimeter (DSC) of 70° C. to 90° C.

Further, it is important that TgA and P1 described above satisfy the relationship of 15° C.≦P1−TgA≦50° C. When the above conditions are satisfied, the binder resin can be caused to adhere to a transfer material to an additionally large extent at the time of the heating and pressurization of the toner. As a result, the low-temperature fixability of the toner can be improved.

TgA described above falls within the range of preferably 40° C. to 55° C., or more preferably 40° C. to 50° C.

In addition, P1 described above falls within the range of preferably 70° C. to 85° C., or more preferably 70° C. to 80° C.

Further, the above difference P1−TgA falls within the range of preferably 15° C. to 40° C., or more preferably 20° C. to 40° C.

When TgA described above is 40° C. to 60° C., the adhesive force of the toner to paper upon fixation at a low temperature is increased, and the low-temperature fixability is improved.

In addition, when P1 is 70° C. to 90° C., a transfer material is prevented from winding around a photosensitive member at a high temperature to an enlarged extent by virtue of moderate bleeding performance of the wax. Further, the adhesive force of the toner to paper is increased by a plasticizing effect of the wax on the toner, and the low-temperature fixability is improved.

Further, when the temperature difference between P1 and TgA is 15° C. to 50° C., the bleeding of the wax to the toner surface is optimized, the fixable temperature range of the toner is expanded, and the transfer material is prevented from winding around the photosensitive member to an enlarged extent. Further, the adhesive force of the toner to paper is increased, and the low-temperature fixability is improved.

It should be noted that TgA, P1, and (P1−TgA) described above can be adjusted to fall within the above ranges by controlling the kind and addition amount of the wax, and the kind and addition amount of the binder resin. However, the method for the adjustment is not limited to the foregoing.

TgA and P1 described above were each measured with a differential scanning calorimeter (DSC) “Q1000” (manufactured by TA Instruments Japan) in conformity with ASTM D3418-82 by the following method under the following conditions.

<Measurement Conditions and Method>

(1) Use modulated mode.

(2) Equilibrium is kept at a temperature of 20° C. for 5 minutes.

(3) A modulation of 1.0° C./min is used so that the temperature is increased to 140° C. at 1° C./min.

(4) Equilibrium is kept at a temperature of 140° C. for 5 minutes.

(5) The temperature is reduced to a temperature of 20° C.

About 3 mg of a measurement sample are precisely weighed. The sample is loaded into an aluminum pan, and is subjected to measurement in the measurement temperature range of 20 to 140° C. at a rate of temperature increase of 1° C./min by using an empty aluminum pan as a reference. TgA and P1 described above were determined from the peak position of the DSC curve for the first temperature increase process. To be specific, the temperature of the point of intersection of a line connecting the middle points of baselines before and after the appearance of a change in specific heat in the DSC curve for the first temperature increase process and the DSC curve was defined as the glass transition temperature (TgA).

In addition, the peak temperature (P1) of the highest endothermic peak of the toner is the temperature at which an endothermic peak shows a local maximum. When multiple endothermic peaks are present, an endothermic peak having the highest height from a base line in a region above the endothermic peaks is defined as the highest endothermic peak.

The toner of the present invention has a viscosity at a temperature of 100° C. by a flow tester heating method (which may hereinafter be referred to as “melt viscosity”) of preferably 3.0×10³ Pa·s to 2.0×10⁴ Pa·s, or more preferably 3.0×10³ Pa·s to 1.0×10⁴ Pa·s. When the melt viscosity of the toner is 3.0×10³ Pa·s to 2.0×10⁴ Pa·s, a transfer material is prevented from winding around a fixing unit by moderate bleeding performance of the wax. Further, the adhesive force of the toner with paper is improved, so the low-temperature fixability of the toner is improved. The above melt viscosity can be caused to satisfy the above range by, for example, but not limited to, adjusting the glass transition temperature of the binder resin of the toner or the temperature of the highest endothermic peak of the wax.

In the toner of the present invention, the value for Z(25) satisfies the above range, the core-shell structure is formed, and the adhesiveness between the core layer and the shell layer is high. As a result, even a toner with its melt viscosity set to such a relatively low value as to satisfy the above condition hardly undergoes reductions in its durability and storage stability.

The above melt viscosity of the toner was measured by the following method.

The melt viscosity of the toner in the present invention is the viscosity at 100° C. measured by a flow tester heating method as described above. Measurement is performed with a Flow Tester CFT-500D (manufactured by Shimadzu Corporation) under the following conditions, in accordance with the instruction manual of the device.

Sample: about 1.1 g of the toner are weighed, and are molded into a sample with a pressure molder.

| Die hole diameter: | 0.5 | mm |
|---|---|---|
| Die length: | 1.0 | mm |
| Cylinder pressure: | 9.807 × 105 | Pa |
| Measurement mode: | Temperature increase method | |
| Rate of temperature increase: | 4.0° | C./min |

The viscosities (Pa·s) of the toner at temperatures of 50° C. to 200° C. are measured by the above method, and the melt viscosity (Pa·s) of the toner at a temperature of 100° C. is determined.

The toner particles used in the present invention are preferably toner particles produced by polymerizing a polymerizable monomer composition containing at least a polymerizable monomer, the colorant, and the polar resin in an aqueous medium. The above toner particles are more preferably toner particles produced by a suspension polymerization method.

When the toner particles used in the present invention are directly produced by a suspension polymerization method or the like, the polar resin is incorporated into the polymerizable monomer composition before a polymerization reaction is performed. As a result, in accordance with a balance between the polarity of the polymerizable monomer composition to serve as toner particles and the polarity of the aqueous dispersion medium, the added polar resin forms a thin shell on the surface of each toner particle, whereby toner particles each having a core-shell structure are obtained.

That is, the addition of the polar resin can control the strength of the shell portion of the core-shell structure. As a result, the durability and fixing performance of the toner can be optimized.

The polar resin used in the present invention is not particularly limited as long as the toner has an acid value of 3.0 mgKOH/g to 40.0 mgKOH/g, a peak molecular weight of 3,000 to 250,000, and a ratio Mw/Mn of 1.3 to 4.0. Specific examples of the polar resin include a polycarbonate resin, a polyester resin, an epoxy resin, a styrene-acrylic acid copolymer, a styrene-methacrylic acid copolymer, and a styrene-maleic acid copolymer each having the above nature. A styrene-methacrylic acid copolymer or styrene-acrylic acid copolymer having an acid value of 3.0 mgKOH/g to 40.0 mgKOH/g, a peak molecular weight of 3,000 to 50,000, and a ratio Mw/Mn of 1.3 to 3.0 is particularly preferably used as the polar resin because the addition amount of the copolymer at the time of the production of the toner can be freely controlled. The polar resin is preferably added in an amount of 1 part by mass to 30 parts by mass with respect to 100 parts by mass of the binder resin. The addition amount preferably falls within the above range because the charge quantity distribution of the toner can be kept sharp, and the toner can obtain good fixing performance.

In addition, when a styrene-methacrylic acid copolymer or a styrene-acrylic acid copolymer is used as the polar resin, compatibility between the binder resin and polar resin of the toner becomes good. As a result, the polar resin can be easily present with a concentration gradient from the surface of each toner particle to the center of the particle, the adhesiveness between the core layer and the shell layer is improved, and the durability of the toner tends to be additionally improved.

In addition, when the toner particles are produced by polymerization in the above aqueous medium, the surface of each toner particle is affected by the pH of the aqueous medium and a dispersant in a process for exposing the toner particles to the aqueous medium. As a result, the colorant in each toner particle may precipitate on the surface of the toner particle. To deal with the problem, the coloring compound having a structure represented by the above formula (1) used in the present invention is used, and the relationship between P1 and TgA described above is set within the range of the present invention. In this case, the storage stability of the toner can be improved. In addition, the shell layer is surely formed of the polar resin, whereby the colorant is appropriately held in each toner particle. Then, the precipitation of the colorant on the surface of each toner particle is suppressed, whereby the contamination of the control member or photosensitive member with the colorant in a developing step is alleviated.

Further, a rise in difficulty with which the colorant precipitates on the surface of each toner particle is synonymous with the achievement of an ability to incorporate the colorant into the toner particle, so the light fastness of the colorant is improved. This is probably because the resin on the surface of each toner particle blocks the transmission of light to reduce damage to the colorant.

Although a detailed reason for the emergence of the above effect when the coloring compound having a structure represented by the above formula (1) is used is unclear, the inventors of the present invention consider the reason as described below. A weak hydrogen bond is formed between the oxygen atom of the carbonyl group (—CO—) to which R₃ is bonded and the hydrogen atom of the hydroxy group (—OH) present at the para position of R₂. As a result, the deterioration of the coloring compound due to heat or light hardly occurs, and the light fastness of the coloring compound is improved. In addition, the contamination of a member the growth of which originates from the decomposition product of the coloring compound can be effectively suppressed.

Further, a toner using the coloring compound can continue to maintain the values for Z(25) and Z(50) within suitable ranges even when the toner is used over a long time period. Although a detailed reason for the emergence of the effect is unclear, the inventors of the present invention consider the reason as follows: an interaction between the above-mentioned hydrogen bond and the polar resin arises to act effectively on the durability of the toner. It should be noted that the coloring compound entirely behaves as a non-polar substance because the hydrogen bond is weak. Accordingly, the coloring compound hardly migrates or diffuses in a polar medium such as the aqueous medium. As a result, a reduction in coloring power of the toner and the contamination of a member can be effectively suppressed.

It should be noted that, in the present invention, the peak molecular weight and the molecular weight distribution were measured by the following measurement method. First, a measurement sample was produced as described below.

The sample was prepared as described below. The toner as a measuring object and tetrahydrofuran (THF) were mixed so that the concentration of the toner in the mixture might be 5 mg/ml. Then, the mixture was left to stand at room temperature for 5 hours. After that, the mixture was sufficiently shaken, and THF and the sample were mixed well with each other until the coalesced body of the sample disappeared. Further, the mixture was subjected to still standing at room temperature for 24 hours. After that, the mixture was passed through a sample treatment filter (a Maishori Disk H-25-2 manufactured by TOSOH CORPORATION or an Ekicrodisc 25CR manufactured by Gelman Science Japan Co., Ltd.), and the resultant was prepared as a sample for gel permeation chromatography (GPC).

The molecular weight distribution and peak molecular weight of the prepared sample were measured with a GPC measuring apparatus (HLC-8120 GPC manufactured by TOSOH CORPORATION) in accordance with the operation manual of the apparatus under the following measurement conditions.

<Measurement Condition>

Apparatus: High-speed GPC “HLC8120 GPC” (manufactured by TOSOH CORPORATION)

Column: Shodex KF-801, 802, 803, 804, 805, 806, and 807, seven columns are connected (manufactured by SHOWA DENKO K.K.)

Eluting solution: THF

Flow rate: 1.0 ml/min

Oven temperature: 40.0° C.

Sample injection amount: 0.10 ml

In addition, in the calculation of the molecular weight of the sample, as a calibration line, a molecular weight correction curve produced with standard polystyrene resins (manufactured by TOSOH CORPORATION; TSK standard polystyrene F-850, F-450, F-288, F-128, F-80, F-40, F-20, F-10, F-4, F-2, F-1, A-5000, A-2500, A-1000, and A-500).

In addition, in the present invention, the acid value (mgKOH/g) of the polar resin was measured by the following method and determined from the following calculation formula.

Acid value=[(terminal point of sample−terminal point of blank)×1.009×56× 1/10]/mass of sample

(Sample Preparation)

1.0 g of sample was precisely weighed in a 200-ml beaker, and dissolved in 120 ml of toluene under stirring with a stirrer. Further, 30 ml of ethanol was added.

(Apparatus)

A potentiometric automatic titration apparatus AT-400WIN (manufactured by Kyoto Electronics Industry Co., Ltd) was used as an apparatus. The setting of the apparatus was intended for a sample to be dissolved in an organic solvent. A glass electrode and a reference electrode used were each adaptable to the organic solvent.

A product code #100-H112 (manufactured by Kyoto Electronics Industry Co., Ltd) was used as a pH glass electrode, and a product code #100-R115 (manufactured by Kyoto Electronics Industry Co., Ltd) was used as a cork reference electrode. A 3.3-mol/l KCl solution was used as an internal liquid.

(Measurement Procedure)

The prepared sample was set in the automatic sampler of the apparatus, and the electrodes were immersed in a solution of the sample. Next, a titrant (0.1-mol/l solution of KOH in ethanol) was set above the solution of the sample, and was dropped in amounts of 0.05 ml each by automatic intermittent titration. The amount of the dropped titrant was measured, and the acid value was calculated from the above formula.

The toner of the present invention may contain a releasing agent. The above releasing agent may include the following. Petroleum waxes such as a paraffin wax, a microcrystalline wax, and petrolatum, and derivatives thereof; a montan wax and derivatives thereof; a hydrocarbon-based wax according to a Fischer-Tropsch method and derivatives thereof; polyolefin waxes such as a low molecular weight polyethylene wax and low molecular weight polypropylene wax, and derivatives thereof; and natural waxes such as a carnauba wax and a candelilla wax, and derivatives thereof.

Examples of the derivatives include an oxide, a block copolymer with a vinyl-based monomer, and a graft denatured product.

Further, the following can be exemplified. Higher aliphatic alcohols; fatty acids such as stearic acid and palmitic acid; acid amide waxes; ester waxes; cured castor oils and derivatives thereof; plant waxes; and animal waxes.

Of those, an ester wax and a hydrocarbon-based wax are particularly preferable because each of the waxes is excellent in releasing performance.

Further, in the toner of the present invention, a hydrocarbon-based wax is more preferably used in order that the core-shell structure may be easily controlled, and an effect of the present invention may be easily exerted.

The content of the above releasing agent is preferably 5 parts by mass to 25 parts by mass with respect to 100 parts by mass of the binder resin. When the content of the releasing agent is 5 parts by mass to 25 parts by mass, the wax component can show moderate bleeding performance at the time of the heating and pressurization of the toner, whereby a transfer material is prevented from winding around a photosensitive member. Further, the extent to which the releasing agent is exposed to the surface of the toner owing to a stress which the toner receives at the time of development or transfer is reduced, so each toner particle can obtain uniform triboelectric charging performance.

The following may be given as examples of the polymerization initiator to be used in the manufacture of the above binder resin. Azo type or diazo type polymerization initiator such as 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile; and the peroxide-based polymerization initiator such as benzoylperoxide, methylethylketoneperoxide, diisopropylperoxycarbonate, cumene hydroperoxide, 2,4-dichlorobenzoylperoxide, lauroylperoxide, and tert-butyl-peroxypivalate.

The usage of each of the above polymerization initiators, which varies depending on the target degree of polymerization, is generally 3 parts by mass to 20 parts by mass with respect to 100 parts by mass of the vinyl-based polymerizable monomer. The number of kinds of polymerization initiators varies slightly depending on a polymerization method. One kind of the polymerization initiators may be used alone, or two or more kinds of them may be used as a mixture with reference to a 10-hour half-life temperature.

In the present invention, polymers each having a sulfonic group, a sulfonate group, or a sulfonic acid ester group at any one of its side chains are each preferably used mainly for the control of the charge of the toner or the stabilization of granulation in an aqueous medium. Of those, a polymer or copolymer having a sulfonic group, a sulfonate group, or a sulfonic acid ester group is particularly preferably used. When the toner of the present invention is produced by a suspension polymerization method, the addition of the above polymer promotes the formation of the core-shell structure of each toner particle at a polymerization stage as well as the stabilization of granulation. As a result, compatibility between the durability and fixing performance of the toner can be achieved to an additionally large extent.

Examples of the monomer having a sulfonic group, a sulfonate group, or a sulfonic acid ester group for producing the above polymer include styrene sulfonic acid, 2-acrylamide-2-methylpropane sulfonic acid, 2-methacrylamide-2-methylpropane sulfonic acid, vinyl sulfonic acid, or methacryl sulfonic acid and alkylesters thereof.

The polymer containing a sulfonic group, a sulfonate group, or a sulfonic acid ester group to be used in the present invention may be a homopolymer of any such monomer as described above, or may be a copolymer of any such monomer as described above and any other monomer. A monomer that forms a copolymer with any such monomer as described above is a vinyl-based polymerizable monomer, and a monofunctional polymerizable monomer or a polyfunctional polymerizable monomer can be used.

In the toner of the present invention, a charge control agent may be added as required and a colorless charge control agent is preferably used in terms of the coloring property. Examples of the charge control agent include a charge control agent having a quarternary ammonium salt structure and a charge control agent having a calixarene structure. Blending of the charge control agent can stabilize charging property and can control a triboelectric charge amount in accordance with a developing system.

A known agent can be used as the charge control agent. In particular, a charge control agent having a high charging speed and capable of stably maintaining a constant charge amount is preferable. Furthermore, when toner is directly produced by means of a polymerization method, a charge control agent having low polymerization inhibiting property and substantially free of any matter soluble in an aqueous dispersion medium is particularly preferable.

The organic metal compound and the chelate compound are exemplified as the above charge control agent for controlling a toner to negative charge. Specific examples of the charge control agent include a monoazo metal compound, an acetylacetone metal compound, a metal compound of aromatic oxycarbonate, aromatic dicarbonate, oxycarbonate, or dicarbonate. Examples of the other charge control agents include: aromatic oxycarbonate, aromatic monocarbonate and aromatic polycarbonate and metal salts and anhydrides and esters thereof; and phenol derivatives such as bisphenol. In addition, examples of the charge control agent also include urea derivatives, a metal-containing salicyclic acid-based compound, a metal-containing naphthoic acid-based compound, a boric compound, quaternary ammonium salts, calixarene, a resin type charge control agent.

On the other hand, examples of a charge control agent for controlling a toner to positive charge include the following. Nigrosine and nigrosine-modified products modified by aliphatic metal salts; a guanidine compound; an imidazole compound; quaternary ammonium salts such as tributylbenzylammonium-1-hydroxy-4-naphthosulfonic acid salts and tetrabutylammonium tetrafluoroborate, onium salts such as a phosphonium salt which are analogs thereof, and a lake pigment thereof; a triphenylmethane dye and a lake pigment thereof (examples of a laking agent include phosphorus tungstate, phosphorus molybdate, phosphorus tungstatemolybdate, tannin acid, lauric acid, gallic acid, ferricyanide, ferrocyanide); metal salts of higher fatty acids; and resin type charge control agents.

The toner of the present invention can contain one kind of those charge control agents alone, or can contain two or more kinds of them in combination.

Of those charge control agents, in terms of improving effects of the present invention, a metal-containing salicylic acid-based compound is preferable. In particular, the metal is preferably aluminum or zirconium.

The most preferable charge control agent is an aluminum 3,5-di-tert-butylsalicylate compound.

The loading of the above charge control agent is preferably 0.01 part by mass to 20 parts by mass, or more preferably 0.5 part by mass to 10 parts by mass with respect to 100 parts by mass of the binder resin.

However, the addition of a charge control agent is not essential to the toner of the present invention. The active utilization of triboelectric charging between a toner layer thickness control member and a toner carrying member eliminates the need for adding a charge control agent to the toner.

In the present invention, inorganic and organic fine particles may be externally added for the purposes of improving the flowability of the toner (fine particles used for such purpose are collectively referred to as “flowability improver”) and uniformizing the charge of the toner. For example, silica fine particles or titania fine particles are preferably used as the fine particles to be externally added. It should be noted that the fine particles have a number-average primary particle diameter of preferably 4 nm to 80 nm, or more preferably 10 nm to 50 nm. The fine particles to be externally added are preferably added in an amount of 0.1 part by mass to 20 parts by mass with respect to 100 parts by mass of the toner particles.

The inorganic fine particles to be externally added to the toner particles to be used in the present invention are preferably silica fine particles. The silica fine particles more preferably have a number average primary particle diameter of 4 nm to 80 nm. In the present invention, when the number average primary particle diameter of the silica fine particles falls within the above range, the flowability of the toner is improved, and the storage stability of the toner tends to become favorable.

Examples of the silica fine particles include: fine particles of dry silica produced by the vapor phase oxidation of a silicon halide or dry silica referred to as fumed silica; and fine particles of wet silica produced from water glass. As the silica fine particles, the dry silica is preferable because it has a small amount of silanol groups on its surface and in the silica fine particles and produces a small amount of a production residue such as Na₂O or SO₃²⁻. In addition, composite fine particles of the dry silica and any other metal oxide can be obtained by using a metal halogen compound such as aluminum chloride or titanium chloride in combination with a silicon halogen compound in a production step, and such composite fine particles are also included in the silica fine particles of the present invention.

Further, as the above fine particles, fine particles subjected to a hydrophobic treatment are preferably used because subjecting the fine particles to a hydrophobic treatment can impart functions of, for example, adjusting the charge amount of the toner, improving environmental stability, and improving properties in a high-humidity environment to the fine particles. When the fine particles added to the toner absorb moisture, the charge amount of the toner tends to reduce, so reductions in developability and transferability may occur.

Examples of a treatment agent for the hydrophobic treatment of the above fine particles include undenatured silicone varnishes, various denatured silicone varnishes, undenatured silicone oils, various denatured silicone oils, silane compounds, silane coupling agents, other organic silicon compounds, and organic titanium compounds. One kind of those treatment agents may be used alone, or two or more kinds of them may be used in combination. Of those, fine particles treated with a silicone oil are preferable. More preferably, fine particles are subjected to a hydrophobic treatment with a coupling agent and treated with a silicone oil simultaneously with or after the fine particles are hydrophobic treated with the coupling agent. The fine particles subjected to a hydrophobic treatment are preferable for maintaining a high triboelectric charge amount of each toner particle even in a high-humidity environment and for reducing selective developability.

Any one of known inorganic and organic dispersants can be used as the dispersant used at the time of the preparation of the aqueous dispersion medium in the above suspension polymerization method.

Specific examples of the inorganic dispersant include the following.

Tricalcium phosphate, magnesium phosphate, aluminum phosphate, zinc phosphate, magnesium carbonate, calcium carbonate, calcium hydroxide, magnesium hydroxide, aluminum hydroxide, calcium metasilicate, calcium sulfate, barium sulfate, bentonite, silica, and alumina.

On the other hand, examples of the organic dispersant include polyvinyl alcohol, gelatin, methylcellulose, methylhydroxypropylcellulose, ethylcellulose, sodium salts of carboxymethylcellulose, and starch.

In addition, a commercially available nonionic, anionic, or cationic surface active agent can be used at the time of the preparation of the above aqueous dispersion medium. Examples of the above surface active agent include the following. Sodium dodecyl sulfate, sodium tetradecyl sulfate, sodium pentadecyl sulfate, sodium octyl sulfate, sodium oleate, sodium laurate, potassium stearate, and calcium oleate.

An inorganic, hardly water-soluble dispersant is preferably used as the dispersant at the time of the preparation of the above aqueous dispersion medium, and a hardly water-soluble, inorganic dispersant which is soluble in an acid is particularly preferably used as the dispersant.

When an aqueous dispersion medium is prepared by using the above hardly water-soluble, inorganic dispersant, the usage of such dispersant is preferably 0.2 part by mass to 2.0 parts by mass with respect to 100 parts by mass of a vinyl-based polymerizable monomer. In addition, in the present invention, an aqueous dispersion medium is preferably prepared with water in an amount of 300 parts by mass to 3,000 parts by mass with respect to 100 parts by mass of a polymerizable monomer composition.

In the present invention, when an aqueous dispersion medium into which the hardly water-soluble, inorganic dispersant as described above is dispersed is prepared, a commercially available dispersant may be dispersed as it is. In addition, in order to obtain dispersant particles each having a fine, uniform grain size, an aqueous dispersion medium may be prepared by producing the hardly water-soluble, inorganic dispersant as described above in a liquid medium such as water under high-speed stirring. For example, when tricalcium phosphate is used as a dispersant, a preferable dispersant can be obtained by mixing an aqueous solution of sodium phosphate and an aqueous solution of calcium chloride under high-speed stirring to form fine particles of tricalcium phosphate.

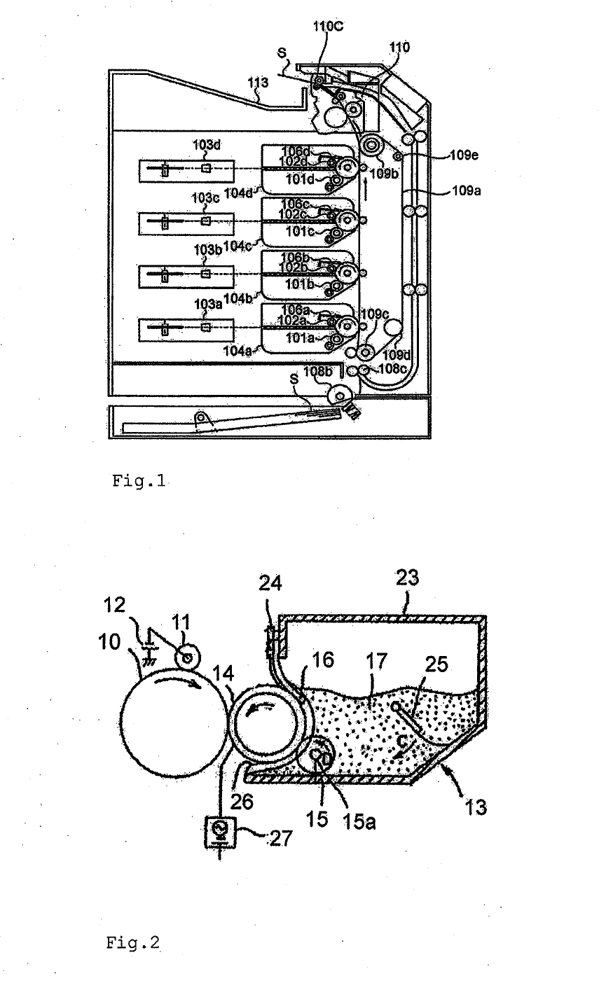

Next, an example of an image-forming method used in the present invention will be described with reference to FIGS. 1 and 2.

FIG. 1 illustrates a sectional drawing of a tandem color laser printer employing a electrophotographic process.

In FIG. 1, reference symbols 101 (101a to 101d) represent drum type electrophotographic photosensitive members (hereinafter referred to as “photosensitive drums”) as latent image bearing members each of which rotates in the direction indicated by an arrow shown in the figure (counterclockwise direction) at a predetermined process speed. The photosensitive drums 101a, 101b, 101c, and 101d are responsible for the yellow (Y) component, magenta (M) component, cyan (C) component, and black (Bk) component of a color image, respectively.

Hereinafter, each image-forming apparatus for Y, M, C, and Bk are referred to as unit a, unit b, unit c, and unit d, respectively.

The photosensitive drums 101a to 101d are each rotated by an unshown drum motor (DC servo motor). The respective photosensitive drums 101a to 101d may be provided with driving sources independent of one another. It should be noted that the rotation of each of the drum motors is controlled by an unshown digital signal processor (DSP), and any other control is performed by an unshown CPU.

In addition, an electrostatic adsorption transport belt 109a is tensioned around a driver roller 109b, fixed rollers 109c and 109e, and a tension roller 109d, and is rotated in the direction indicated by an arrow by the driver roller 109b to adhere to and transport a recording medium S.

Hereinafter, description will be given by taking a unit a (yellow) out of the four colors as an example.

The photosensitive drum 101a is uniformly subjected to a primary charging treatment by primary charging means 102a during its rotation process so as to have predetermined polarity and a predetermined potential. Then, the photosensitive drum 101a is exposed to light by laser beam exposing means (hereinafter referred to as “scanner”) 103a, whereby an electrostatic latent image of image information is formed on the photosensitive drum 101a.

Next, the electrostatic latent image is visualized by a developing portion 104a, whereby a toner image is formed on the photosensitive drum 101a. Similar steps are performed for the other three colors (magenta (M), cyan (C), and black (Bk)).

Next, four color toner images are synchronized by a resist roller 108c which stops and transfers the recording medium S, which is transported at a timing adjusted by a sheet feeding roller 108b, and at a nip portion between each of the photosensitive drums 101a to 101d and the electrostatic adsorption transport belt 109a, the four color toner images are sequentially transferred onto the recording medium S. In addition, at the same time, a residual adhering substance such as transfer residual toner is removed from the photosensitive drums 101a to 101d by cleaning means 106a, 106b, 106c, and 106d after the toner images have been transferred onto the recording medium S.

The recording medium S onto which the toner images have been transferred from the four photosensitive drums 101a to 101d is separated from the surface of the electrostatic adsorption transport belt 109a at the driver roller 109b portion so as to be fed into a fixing unit 110. Then, the toner images are fixed on the recording medium S in the fixing unit 110. After that, the medium is discharged to a discharge tray 113 by a discharge roller 110c.

Next, a specific example of an image-forming method in a non-magnetic, one-component, contact developing system will be described with reference to an enlarged view of a developing portion (FIG. 2). In FIG. 2, a developing unit 13 includes: a developer container 23 storing a non-magnetic toner 17 as a one-component developer; a stirring member 25 stirring the non-magnetic toner in the developer container; a latent image bearing member (photosensitive drum) 10 positioned at an opening extending in the longitudinal direction of the developer container 23; and a toner carrying member 14 placed so as to develop and visualize the latent image on the latent image bearing member 10. A charging member contacting latent image bearing member 11 contacts the latent image bearing member 10. The bias of the charging member contacting latent image bearing member 11 is applied by a power supply 12.

The toner carrying member 14 is installed laterally while substantially the right half of its circumferential surface shown in the figure is exposed to the inside of the developer container 23 and substantially the left half of its circumferential surface shown in the figure is exposed to the outside of the developer container 23 at the opening. The surface exposed to the outside of the developer container 23 contacts the latent image bearing member 10 positioned on the left side of the developing unit 13 in FIG. 2 as shown in the figure. Further, a seal member 26 is provided to prevent the non-magnetic toner from leaking out of the developer container.

The circumferential speed of the latent image bearing member 10 is 50 to 200 mm/s, and the toner carrying member 14 rotates in the direction indicated by an arrow at a circumferential speed one time to twice as high as that of the latent image bearing member 10.

A control member 16 is supported by a control member support plate 24 above the toner carrying member 14. The control member uses a metal plate formed of, for example, SUS, a rubber material such as urethane or silicone, or a metal thin plate formed of SUS having rubber elasticity or phosphor bronze as a substrate. A rubber material is bonded to the side of the surface of the control member contacting the toner carrying member 14. The control member 16 is provided so that the vicinity of its edge on a free edge side contacts the outer circumferential surface of the toner carrying member 14 by surface contact. The direction in which the vicinity contacts the outer circumferential surface is a counter direction in which the tip side is positioned on the upstream side relative to the contact portion of the direction in which the toner carrying member 14 rotates. An example of the control member 16 is a constitution in which plate-like urethane rubber having a thickness of 1.0 mm is bonded to the control member support plate 24 and the contact pressure (linear pressure) at which the control member contacts the toner carrying member 14 is appropriately set. The contact pressure is preferably 20 to 300 N/m. The contact pressure is measured as follows: three metal thin plates each having a known coefficient of friction are inserted into the portion where the control member and the toner carrying member contact each other, and the value of a force needed for pulling the center plate with a spring balance is converted into the contact pressure. It should be noted that a rubber material is preferably bonded to the surface of the control member 16 contacting the toner carrying member in terms of adhesiveness with toner; the melt adhesion and sticking of the toner to the control member upon long-term use of the toner can be suppressed. In addition, the control member 16 can contact the toner carrying member 14 in an edge contact fashion as described below: an edge of the control member is brought into contact with the toner carrying member. It should be noted that, in the case of the edge contact, the contact angle of the control member 16 relative to the tangent of the toner carrying member at the point where the control member contacts the toner carrying member is more preferably set to 40° or less in terms of the control of the thickness of a toner layer.

The toner feeding roller 15 (15a being the center metal) is brought into contact with the upstream side of the direction in which the toner carrying member 14 rotates relative to the portion where the control member 16 contacts the surface of the toner carrying member 14, and the roller is rotatably supported. An effective width at which the toner feeding roller 15 contacts the toner carrying member 14 is 1 to 8 mm, and the toner carrying member 14 is preferably provided with a relative velocity at the portion where the toner feeding roller and the toner carrying member contact each other.

In the developing portion, the toner layer formed into a thin layer on the toner carrying member 14 develops the electrostatic latent image on the latent image bearing member 10 with the aid of the DC bias applied by the power supply 27 shown in FIG. 2 between both the toner carrying member 14 and the latent image bearing member 10 so as to form a toner image.

### EXAMPLES

The present invention is described specifically by way of the following examples. A method of producing toner particles is described below. However, the present invention is not limited to the examples. It should be noted that the terms “part(s)” and “%” in all the examples and comparative examples refer to “part(s) by mass” and “mass %”, respectively unless otherwise stated.

(Synthesis of Coloring Compound)

A coloring compound represented by the following formula D1 corresponding to the above formula (1) was obtained as described below.

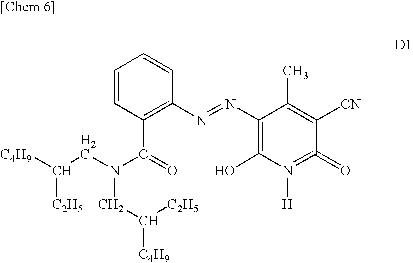

100 parts by mass of chloroform were added to 10 parts by mass of o-nitrobenzoic acid. Under a nitrogen atmosphere, 29 parts by mass of thionyl chloride were dropped to the mixture. After the completion of the dropping, the resultant was subjected to a reaction at 60° C. for 1 hour. The resultant reaction mixture was cooled with ice to 10° C. or lower, and 9 parts by mass of triethylamine and 15 parts by mass of di(2-ethylhexyl)amine were dropped to the mixture. After the completion of the dropping, the resultant was subjected to a reaction at 80° C. for 2 hours. After the completion of the reaction, the reaction product was extracted with chloroform, and the resultant solution was concentrated, whereby 18 parts by mass of a compound represented by the following formula C1 as an intermediate were obtained.

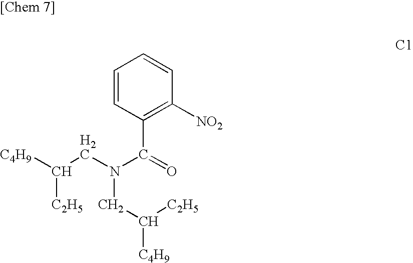

50 parts by mass of ethanol were added to 10 parts by mass of the compound represented by the above formula C1. Further, 18 parts by mass of a 20% aqueous solution of sodium hydrosulfide were added to the mixture, and the whole was subjected to a reaction at 75° C. for 1 hour. After the completion of the reaction, the reaction product was extracted with chloroform, and the resultant solution was concentrated, whereby 7.4 parts by mass of a compound represented by the following formula C2 as an intermediate were obtained.

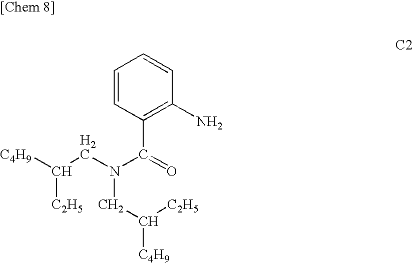

3.4 parts by mass of concentrated hydrochloric acid and 59 parts by mass of methanol were added to 5.9 parts by mass of the compound represented by the above formula C2, and the resultant solution was cooled with ice to 10° C. or lower. A solution prepared by dissolving 1.4 parts by mass of sodium nitrite in 2.0 parts by mass of water was added to the above solution, and the mixture was subjected to a reaction at the temperature for 1 hour. Next, 0.5 part by mass of sulfamic acid was added to the reaction product, and the mixture was stirred for an additional 20 minutes (diazonium salt solution).

Next, 2.7 parts by mass of a compound represented by the following formula C3 were dissolved by adding 25 parts by mass of N,N-dimethylformamide. After that, 20 parts by mass of methanol were added to the solution, and the mixture was added to the diazonium salt solution held at 10° C. or lower under ice cooling.

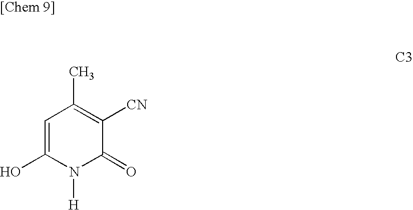

After that, a saturated aqueous solution of sodium carbonate was added to the solution to adjust the pH of the solution to 5 to 6, and the mixture was subjected to a reaction at 10° C. or lower for 2 hours. After the completion of the reaction, the solvent was removed by distillation, and the remainder was purified by column chromatography, whereby 5.2 parts by mass of the coloring compound represented by the above formula D1 were obtained.

The resultant coloring compound represented by the above formula D1 (which may hereinafter be simply referred to as “coloring compound D1”) was tested for its purity with a high performance liquid chromatography (HPLC) (LC2010A manufactured by Shimadzu Corporation). Further, the structure of the compound was determined with a time-of-flight mass spectrometer (TOF-MS) (LC/MSD TOF manufactured by Agilent Technologies) and a nuclear magnetic resonance spectrometer (NMR) (ECA-400 manufactured by JEOL Ltd.). It should be noted that an electrospray-ionization method (ESI) was employed as a method of ionizing the coloring compound represented by the above formula D1 upon mass spectrometry of the coloring compound represented by the above formula D1.

[Analysis Result of Coloring Compound D1]

Result of HPLC>

(Elusing solution=CH₃OH:H₂O=90:10, flow rate=1.0 ml/min, detection wavelength=254 nm) retention time=9.6 minutes, purity=99.5 area %.

<Result of ESI-TOF-MS>

m/z=522.3458 (M⁺)

<Result of 1H NMR (400 MHz, CDCl3, room temperature) (refer to FIG. 4)>

δ[ppm]=8.59 (1H, s), 7.87 (1H, d), 7.54-7.49 (1H, m), 7.30 (2H, m), 3.52 (2H, s), 3.25 (2H, d), 2.64 (3H, s), 1.86-1.82 (1H, m), 1.51-0.63 (30H, m)

<Result of 13C NMR (100 MHz, CDCl₃, room temperature)>

δ[ppm]=10.30, 10.52, 13.86, 14.02, 16.83, 22.87, 23.05, 23.20, 23.82, 28.27, 28.52, 30.02, 30.53, 36.81, 37.13, 47.21, 52.66, 101.79, 113.93, 117.10, 123.84, 126.04, 126.21, 127.99, 130.95, 139.53, 159.79, 159.98, 160.83, 169.08

Coloring compounds D2 to D16 were each synthesized by a method in conformance with the above synthesis example so that R₁ to R₇ in the following formula (1) might each represent a group shown in Table 1. It should be noted that a compound having a low purity was repeatedly purified so that its purity might be increased; finally, a high-purity compound was obtained. The structure of each of those coloring compounds D2 to D16 was identified by HPLC, mass spectrometry, and NMR in the same manner as in the coloring compound D1. It should be noted that the symbols “Ph” and “Me” in Table 1 refer to a phenyl group and a methyl group, respectively. In addition, FIG. 4 shows the ¹H-NMR spectrum chart of the above coloring compound D1.

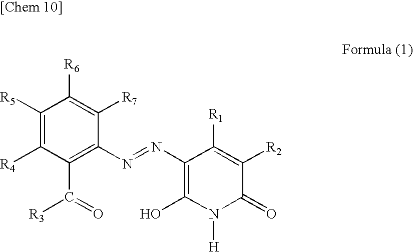

TABLE 1

| Compound | | | | | | | |
|---|---|---|---|---|---|---|---|
| number | R₁ | R₂ | R₃ | R₄ | R₅ | R₆ | R₇ |
| D2 | -Ph | —CN | —N[CH₂CH(C₂H₅)C₄H₉]₂ | —H | —H | —H | —H |
| D3 | —CH₃ | —CN | —N(C₆H₁₃)₂ | —H | —H | —H | —H |
| D4 | —CH₃ | —CN | —N(C₁₂H₂₅)₂ | —H | —H | —H | —H |
| D5 | —CH₃ | —CN | —N(C₁₂H₂₅)₂ | —H | —Cl | —H | —H |
| D6 | —C₄H₉ | —CN | —O[CH₂CH(C₂H₅)C₄H₉] | —H | —CH₃ | —H | —H |
| D7 | —CH₃ | —H | —N[CH₂CH(C₂H₅)C₄H₉]₂ | —H | —H | —H | —H |
| D8 | —CH₃ | —CN | 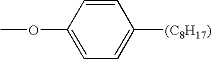 | —H | —H | —H | —H |
| D9 | —C₄H₉ | —CN | 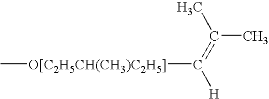 | —H | —H | —CH₃ | —H |
| D10 | —C₄H₉ | —CN | —OCHPh₂ | —H | —OCH₃ | —H | —H |
| D11 | —CH₃ | —CN | 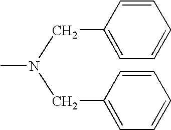 | —H | —H | —H | —H |
| D12 | —CH₃ | —CN | —NPh₂ | —H | —H | —H | —H |
| D13 | —C₄H₉ | —CN | 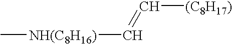 | —H | —NO₂ | —H | —H |
| D14 | —CH₃ | —CONH₂ | —N[CH₂CH(C₂H₅)C₄H₉]₂ | —H | —H | —H | —H |
| D15 | —C₄H₉ | —CN | —NHCH₂CH(C₂H₅)C₄H₉ | —H | —H | —H | —H |
| D16 | —C₄H₉ | —CN | 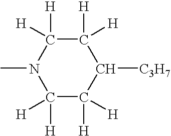 | —H | —H | —H | —H |

Comparative compounds E1 to E11 in each of which R′₁ to R′₈ in the following formula (2) each represented a group shown in Table 2 were each synthesized by a method in conformance with the synthesis example of the above coloring compound D1. Yellow toners were produced with the comparative compounds (E1 to E11) and the above coloring compounds (D1 to D16) as colorants by the following procedure.

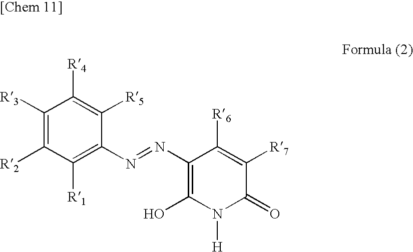

TABLE 2

| Com- | | | | | | | | |
|---|---|---|---|---|---|---|---|---|
| pound | | | | | | | | |
| number | R′₁ | R′₂ | R′₃ | R′₄ | R′₅ | R′₆ | R′₇ | R′₈ |
| E1 | —H | —H | —C₄H₉ | —H | —H | —CH₃ | —CN | —H |
| E2 | —H | —H | —Cl | —H | —H | —CH₃ | —CN | —C₄H₉ |
| E3 | —H | —H | —SO₂NHCH₂CH(C₂H₅)C₄H₉ | —H | —H | —CH₃ | —CN | —C₄H₉ |
| E4 | —H | —H | —N(CH₃)₂ | —H | —H | —CH₃ | —CN | —C₂H₄Cl |
| E5 | —H | —H | —COOCH₃ | —H | —H | —CH₃ | —CN | —C₄H₉ |
| E6 | —H | —H | —CON[CH₂CH(C₂H₅)C₄H₉]₂ | —H | —H | —CH₃ | —CN | —C₂H₅ |
| E7 | —H | —H | —H | —CH₃ | —H | —CH₃ | —CN | —C₄H₉ |
| E8 | —NO₂ | —H | —H | —H | —H | —CH₃ | —CN | —C₄H₉ |
| E9 | —H | —CON[CH₂CH(C₂H₅)C₄H₉]₂ | —H | —H | —H | —CH₃ | —CN | —H |
| E10 | —H | —H | —CON[CH₂CH(C₂H₅)C₄H₉]₂ | —H | —H | —CH₃ | —CN | —H |
| E11 | —CON[CH₂CH(C₂H₅)C₄H₉]₂ | —H | —H | —H | —H | —CH₃ | —CN | —C₂H₅ |

### Example 1

A yellow toner was produced by the following procedure.

The following materials were dissolved with a propeller type stirring apparatus at 100 r/min, whereby a solution was prepared.

| | | |
|---|---|---|
| Styrene | 70.0 | parts by mass |
| n-butyl acrylate | 30.0 | parts by mass |
| Sulfonate group-containing resin (Acryl Base | 2.0 | parts by mass |
| FCA-1001-NS manufactured by Fujikura Kasei | | |
| Co., Ltd.) | | |
| Polar resin (styrene/methacrylic acid/methyl | 20.0 | parts by mass |
| methacrylate/α-methylstyrene copolymer) | | |
| (styrene: methacrylic acid:methyl | | |
| methacrylate:α-methylstyrene = | | |
| 80.85:2.50:1.65:15.00 (on a mass basis), | | |
| Mp = 19,700, Mw = 7,900, acid value = | | |
| 12.0 mgKOH/g, Mw/Mn = 2.1) | | |
| Coloring compound D1 | 6.0 | parts by mass |
| Negative charge control agent (Bontron | 2.0 | parts by mass |
| E-88 manufactured by Orient Chemical | | |
| Industries, Ltd.) | | |
| Hydrocarbon-based wax having a melting | 8.0 | parts by mass |
| point of 77° C. (HNP-51 manufactured by | | |
| NIPPON SEIRO CO., LTD.) | | |

The above solution was heated to a temperature of 60° C., and was then stirred with a TK-homomixer (manufactured by Tokushu Kika Kogyo) at 9,000 r/min so that the contents might be dissolved and dispersed.

In addition, an aqueous solution of sodium hydroxide prepared by dissolving 7 parts of sodium hydroxide in 100 parts of ion-exchanged water was gradually added to an aqueous solution of magnesium chloride prepared by dissolving 12.0 parts of magnesium chloride in 500 parts of ion-exchanged water while the latter aqueous solution was stirred. Thus, an aqueous medium containing a magnesium hydroxide colloid was prepared.

The solution was charged into the aqueous medium, and the mixture was stirred at a temperature of 60° C. with the TK-homomixer at 15,000 r/min for 10 minutes so as to be granulated. 8.5 parts of a polymerization initiator 2,2′-azobis(2,4-dimethylvaleronitrile) were dissolved in the resultant, whereby a polymerizable monomer composition was prepared.

After that, the resultant was transferred to the propeller type stirring apparatus, and was subjected to a reaction at a temperature of 65° C. for 5 hours while being stirred at 100 r/min. After that, the temperature of the reaction product was increased to 80° C., and the product was subjected to a reaction for 5 hours. After the completion of the polymerization reaction, slurry containing the particles was cooled, washed with water in an amount fifteen times as large as that of the slurry, filtrated, and dried. After that, particle diameters were adjusted by classification, whereby yellow toner particles were obtained.

2.0 parts by mass of a hydrophobic silica fine powder (number average primary particle diameter: 10 nm, BET specific surface area: 170 m2/g) as a flowability improver treated with dimethyl silicone oil (20%) and charged in a triboelectric fashion with polarity identical to that of each of the toner particles (negative polarity) were mixed in 100 parts by mass of the above yellow toner particles with a Henschel mixer (manufactured by Mitsui Miike Machinery Co., Ltd.) at 3,000 r/min for 15 minutes, whereby Yellow toner 1 was obtained. Table 3 shows the physical properties of Yellow toner 1.

### Examples 2 to 16

Yellow toners were each produced in the same manner as in Example 1 except that the coloring compound D1 in Example 1 was changed to any one of the coloring compounds D2 to D16 shown in Table 2. The resultant toners were defined as Yellow Toners 2 to 16. Table 3 shows the physical properties of Yellow Toners 2 to 16.

### Example 17

A yellow toner was produced in the same manner as in Example 1 except that: the addition amount of styrene and the addition amount of n-butyl acrylate in Example 1 were changed to 65.0 parts by mass and 35.0 parts by mass, respectively; and the hydrocarbon-based wax in Example 1 was changed to a hydrocarbon-based wax having a melting point of 75° C. (Biber™103 manufactured by Toyo Petrolite Co., Ltd.). The resultant toner was defined as Yellow toner 17. Table 3 shows the physical properties of Yellow toner 17.

### Example 18

A yellow toner was produced in the same manner as in Example 1 except that the sulfonate group-containing resin (Acryl Base FCA-1001-NS manufactured by Fujikura Kasei Co., Ltd.) in Example 1 was not added. The resultant toner was defined as Yellow toner 18. Table 3 shows the physical properties of Yellow toner 18.

### Example 19

A yellow toner was produced in the same manner as in Example 1 except that 8.0 parts by mass of behenyl behenate (ester wax) having a melting point of 75° C. were added instead of the hydrocarbon-based wax in Example 1. The resultant toner was defined as Yellow toner 19. Table 3 shows the physical properties of Yellow toner 19.

### Example 20

A yellow toner was produced in the same manner as in Example 1 except that the addition amount of the hydrocarbon-based wax in Example 1 was changed to 3.0 parts by mass. The resultant toner was defined as Yellow toner 20. Table 3 shows the physical properties of Yellow toner 20.

### Example 21

A yellow toner was produced in the same manner as in Example 1 except that the addition amount of the hydrocarbon-based wax in Example 1 was changed to 20.0 parts by mass. The resultant toner was defined as Yellow toner 21. Table 3 shows the physical properties of Yellow toner 21.

### Example 22

A yellow toner was produced in the same manner as in Example 1 except that 20.0 parts by mass of a styrene/methacrylic acid/methyl methacrylate/butyl acrylate copolymer (styrene:methacrylic acid:methyl methacrylate:butyl acrylate=84.00:2.50:1.50:12.00 (on a mass basis), Mp=55,000, Mw=53,000, acid value=11.5 mgKOH/g, Mw/Mn=2.0) were added as a polar resin in Example 1. The resultant toner was defined as Yellow Toner 22. Table 3 shows the physical properties of Yellow Toner 22.

### Example 23

A yellow toner was produced in the same manner as in Example 1 except that 1.0 part by mass of tertiary dodecyl mercaptan was further added in Example 1. The resultant toner was defined as Yellow toner 23. Table 3 shows the physical properties of Yellow toner 23.

### Example 24

A yellow toner was produced in the same manner as in Example 1 except that: the addition amount of styrene and the addition amount of n-butyl acrylate in Example 1 were changed to 78.0 parts by mass and 22.0 parts by mass, respectively. The resultant toner was defined as Yellow toner 24. Table 3 shows the physical properties of Yellow toner 24

### Example 25

A yellow toner was produced in the same manner as in Example 1 except that 20.0 parts by mass of a styrene/methacrylic acid/methyl methacrylate/butyl acrylate copolymer (styrene:methacrylic acid:methyl methacrylate:butyl acrylate=72.0:2.50:1.50:24.0 (on a mass basis), Mp=95,700, Mw=101,900, acid value=11.4 mgKOH/g, Mw/Mn=2.9) were added as a polar resin in Example 1. The resultant toner was defined as Yellow Toner 25. Table 3 shows the physical properties of Yellow Toner 25.

### Example 26

A yellow toner was produced in the same manner as in Example 1 except that 6.0 parts by mass of the coloring compound D1 in Example 1 were changed to 3 parts by mass of the coloring compound D1 and 3 parts by mass of C.I. Pigment Yellow 93. The resultant toner was defined as Yellow Toner 26. Table 3 shows the physical properties of Yellow Toner 26.

### Example 27

A yellow toner was produced by the following procedure.

[Preparation of Resin Fine Particle-Dispersed Liquid]

| | |
|---|---|
| Styrene | 70.0 parts by mass |
| n-butyl acrylate | 30.0 parts by mass |
| Sulfonic group-containing resin (Acryl Base | 2.0 parts by mass |
| FCA-1001-NS manufactured by Fujikura Kasei | |
| Co., Ltd.) | |

The above components were mixed and dissolved. Meanwhile, a solution prepared by dissolving 6 parts by mass of a nonionic surfactant (NONIPOL 400 manufactured by Kao Corporation) and 10 parts by mass of an anionic surfactant (Neogen SC manufactured by Dai-ichi Kogyo Seiyaku Co., Ltd.) in 500 g of ion-exchanged water was stored in a flask, and the above mixed solution was added to the flask so as to be dispersed and emulsified. While the contents in the flask were slowly stirred and mixed for 10 minutes, 50 parts by mass of an aqueous solution prepared by dissolving 4 parts by mass of ammonium persulfate in ion-exchanged water were charged into the flask. Next, the air in the system was sufficiently replaced with nitrogen, and then the flask was heated in an oil bath until the temperature in the system reached 70° C. while the contents in the flask were stirred. Then, emulsion polymerization was continued without any change for 5 hours. Thus, an anionic resin fine particle-dispersed liquid was obtained.

[Preparation of Colorant Particle-Dispersed Liquid]

| | | |
|---|---|---|
| Coloring compound D1 | 6.0 | parts by mass |
| Nonionic surfactant (NONIPOL 400 | 1.0 | part by mass |
| manufactured by Kao Corporation) | | |
| Ion-exchanged water | 100.0 | parts by mass |

The above components were mixed and dissolved, and were then dispersed with a Homogenizer (Ultraturrax manufactured by IKA) for 10 minutes, whereby a colorant particle-dispersed liquid was obtained.

[Preparation of Release Agent Particle-Dispersed Liquid]

| | |
|---|---|
| Hydrocarbon-based wax having a melting | 8.0 parts by mass |
| point of 77° C. (HNP-51 manufactured by | |
| NIPPON SEIRO CO., LTD.) | |
| Cationic surfactant (SANISOL B50 manufactured | 5.0 parts by mass |
| by Kao Corporation) | |
| Ion-exchanged water | 200.0 parts by mass |

The above components were heated to 95° C., and were then sufficiently dispersed with an Ultraturrax T50 manufactured by IKA. After that, the resultant was subjected to a dispersion treatment with a pressure ejection-type homogenizer, whereby a release agent particle-dispersed liquid was obtained.

[Preparation of Shell-Forming Fine Particle-Dispersed Liquid]

20.0 parts by mass of the polar resin used in Example 1 were dissolved in 50.0 parts by mass of ethyl acetate. The solution was heated at a temperature of 80° C. while being emulsified with an Ultraturrax T50 manufactured by IKA. The solution was held at the temperature for 6 hours so that desolvation might be performed. Thus, a shell-forming fine particle-dispersed liquid was obtained.

[Production of Toner Particles]

The above resin fine particle-dispersed liquid, the above colorant particle-dispersed liquid, the above release agent particle-dispersed liquid, and 1.2 parts by weight of polyaluminum chloride were mixed, and were then sufficiently mixed and dispersed in a round bottom flask made of stainless steel with an Ultraturrax T50 manufactured by IKA. After that, the contents in the flask were heated to 51° C. in an oil bath for heating while the contents in the flask were stirred. The contents were held at 51° C. for 60 minutes, and then the above shell-forming fine particle-dispersed liquid was added to the flask. After that, the pH in the system was adjusted to 6.5 with an aqueous solution of sodium hydroxide having a concentration of 0.5 mol/L, and then the flask made of stainless steel was hermetically sealed. The resultant mixture was heated to 97° C. while being continuously stirred by attaching a magnetic seal to the shaft of a stirrer so that the stirrer might continue to rotate with a magnetic force. Then, the mixture was held at the temperature for 3 hours. After the completion of the reaction, the resultant was cooled, filtrated, and sufficiently washed with ion-exchanged water, and then the washed product was subjected to solid-liquid separation by Nutsche suction filtration. Further, the solid content was dispersed again with 3 L of ion-exchanged water at 40° C., and the resultant was stirred and washed for 15 minutes at 300 rpm; the washing operation was repeated five more times. After that, the resultant was subjected to solid-liquid separation by Nutsche suction filtration with a No. 5A filter paper. Next, the resultant was continuously dried in a vacuum for 12 hours, whereby toner particles were obtained. 100 parts of the above toner particles and 2.0 parts of a hydrophobic silica fine powder treated with dimethyl silicone oil (20%) and chargeable to the same polarity (negative polarity) as that of the toner particles (number-average primary particle diameter: 10 nm, BET specific surface area: 170 m²/g) as a flowability improver were mixed with a Henschel mixer (manufactured by Mitsui Miike Machinery Co., Ltd.) at 3,000 r/min for 15 minutes, whereby Yellow Toner 27 was obtained. Table 3 shows the physical properties of Yellow Toner 27.

### Example 28

710 parts by mass of ion-exchanged water and 580 parts by mass of a 0.1-mol/L aqueous solution of Na₃(PO₄)₂ were charged into a reaction vessel provided with a TK-homomixer (manufactured by Tokushu Kika Kogyo), and the mixture was heated to 60° C. After that, the mixture was stirred with a CLEARMIX (emulsifier) at 12,000 r/min. 88 parts by mass of a 1.0-mol/L aqueous solution of CaCl₂ were added to the mixture, whereby an aqueous medium of a compound of phosphoric acid and calcium containing Ca₃(PO₄)₂ and having a pH of 5.0 was obtained.

Meanwhile, first, C.I. Pigment Yellow 93 and 100 parts by mass of a styrene monomer out of the following formulations were dispersed with a TK-homomixer (manufactured by Tokushu Kika Kogyo) for 3 hours, whereby a colorant-dispersed liquid as a dispersoid was obtained. Next, all the remainder of the following formulations were added to the colorant-dispersed liquid, the mixture was heated to a temperature of 60° C., and the remaining formulations were dissolved and mixed for 30 minutes. 8 parts by mass of a polymerization initiator 2,2′-azobis(2,4-dimethylvaleronitrile) were dissolved in the resultant, whereby a polymerizable monomer composition was prepared.

| | | |
|---|---|---|
| Styrene monomer | 160 | parts by mass |
| 2-ethylhexyl acrylate monomer | 40 | parts by mass |
| Coloring compound D1 | 6 | parts by mass |
| Negative charge control agent (Bontron E-88 | 2 | parts by mass |
| manufactured by Orient Chemical Industries, | | |
| Ltd.) | | |
| Polycondensate of propylene oxide-denatured | 10 | parts by mass |
| bisphenol A and isophthalic acid (glass | | |
| transition temperature (Tg) = 65° C., | | |
| weight-average molecular weight (Mw) = 10,000, | | |
| number-average molecular weight (Mn) = 6,000) | | |
| Ester wax (melting point 70° C., number- | 25 | parts by mass |
| average molecular weight (Mn) = 700) | | |
| Divinylbenzene (purity 55%) | 0.5 | part by mass |

The above polymerizable monomer composition was loaded into the aqueous dispersion medium, and the mixture was granulated for 15 minutes while the number of revolutions of the TK-homomixer as a high-speed stirring machine was maintained. After that, the stirring machine was changed from the high-speed stirring machine to a propeller stirring blade, and polymerization was continued for 5 hours at a temperature in the vessel containing the mixture of 60° C. After that, the temperature was increased to 80° C., and the polymerization was continued for 8 hours. After the completion of the polymerization reaction, the remaining monomers were removed by distillation at 80° C. and under reduced pressure. After that, the remainder was cooled to 30° C., whereby a polymer fine particle-dispersed liquid was obtained.

Next, the polymer fine particle-dispersed liquid was transferred to a washing container, and dilute hydrochloric acid was added to the liquid while the liquid was stirred. The mixture was stirred at a pH of 1.5 for 2 hours so that a compound of phosphoric acid and calcium containing Ca₃(PO₄)₂ might be dissolved. After that, the resultant was subjected to solid-liquid separation with a filter, whereby polymer fine particles were obtained. The fine particles were loaded into water, and the mixture was stirred so that a dispersed liquid might be prepared again. After that, the liquid was subjected to solid-liquid separation with a filter. The re-dispersion of the polymer fine particles in water and solid-liquid separation were repeatedly performed until the compound of phosphoric acid and calcium containing Ca₃(PO₄)₂ was sufficiently removed. After that, polymer fine particles finally obtained by solid-liquid separation were sufficiently dried with a dryer, whereby yellow toner particles were obtained. 100 parts by mass of the above toner particles and 2.0 parts by mass of a hydrophobic silica fine powder treated with dimethyl silicone oil (20%) and chargeable to the same polarity (negative polarity) as that of the toner particles (number-average primary particle diameter: 10 nm, BET specific surface area: 170 m²/g) as a flowability improver were mixed with a Henschel mixer (manufactured by Mitsui Miike Machinery Co., Ltd.) at 3,000 r/min for 15 minutes, whereby Yellow Toner 28 was obtained. Table 3 shows the physical properties of Yellow Toner 28.

### Example 29

A toner was produced by a pulverization method described below.

| | | |
|---|---|---|
| Styrene-butyl acrylate copolymer | 100.0 | parts by mass |
| (Copolymerization ratio “styrene:butyl | | |
| acrylate” = 69:31 (on a mass basis), | | |
| Mp = 22,000, Mw = 35,000, Mw/Mn = | | |
| 2.4, Tg = 45° C.) | | |
| Sulfonic group-containing resin (Acryl | 2.0 | parts by mass |
| Base FCA-1001-NS manufactured by | | |
| Fujikura Kasei Co., Ltd.) | | |
| Coloring compound D1 | 6.0 | parts by mass |
| Negative charge control agent (Bontron | 1.0 | part by mass |
| E-88 manufactured by Orient Chemical | | |
| Industries, Ltd.) | | |
| Hydrocarbon-based wax having a melting | 8.0 | parts by mass |
| point of 77° C. (HNP-51 manufactured by | | |
| NIPPON SEIRO CO., LTD.) | | |

A mixture of the above materials was melted and kneaded with a biaxial extruder heated to 125° C., the kneaded product was cooled, and the cooled product was coarsely pulverized with a hammer mill. The coarsely pulverized products were pulverized with a mechanical pulverizer Turbo mill T-250 type manufactured by Turbo Kogyo Co., Ltd. and classified, whereby yellow toner particles were obtained. Further, 20.0 parts by mass of resin fine particles (number-average particle diameter: 300 nm) having the same composition as that of the styrene/methacrylic acid/methyl methacrylate/α-methylstyrene copolymer (styrene:methacrylic acid:methyl methacrylate:α-methylstyrene=80.85:2.50:1.65:15.0 (on a mass basis), Mp=19,700, Mw=7,900, acid value=12.0 mgKOH/g, Mw/Mn=2.1) used in Example 1 were added to the toner particles, and the mixture was treated with a “Hybridization System” (manufactured by NARA MACHINERY CO., LTD.) so that a shell structure might be formed of the polar resin on the surface of each toner particle. Thus, yellow toner particles were obtained.

100 parts by mass of the yellow toner particles and 2.0 parts by mass of a hydrophobic silica fine powder treated with silicone oil and chargeable to the same polarity (negative polarity) as that of the toner particles (number-average primary particle diameter: 10 nm, BET specific surface area: 170 m²/g) as a flowability improver were mixed with a Henschel mixer (manufactured by Mitsui Miike Machinery Co., Ltd.) for 5 minutes, whereby Yellow Toner 29 was obtained. Table 3 shows the physical properties of Yellow Toner 29.

### Comparative Example 1

A yellow toner was produced in the same manner as in Example 1 except that polymerization was performed by adding 2.0 parts by mass of divinyl benzene in Example 1. The resultant toner was defined as Yellow Toner 30. Table 3 shows the physical properties of Yellow Toner 30.

### Comparative Example 2

A yellow toner was produced in the same manner as in Example 1 except that the addition amount of styrene and the addition amount of n-butyl acrylate in Example 1 were changed to 55.0 parts by mass and 45.0 parts by mass, respectively. The resultant toner was defined as Yellow Toner 31. Table 3 shows the physical properties of Yellow Toner 31.

### Comparative Example 3

A yellow toner was produced in the same manner as in Example 1 except that: the addition amount of styrene and the addition amount of n-butyl acrylate in Example 1 were changed to 80.0 parts by mass and 20.0 parts by mass, respectively; and the wax component in Example 1 was changed to a hydrocarbon-based wax having a melting point of 88° C. (OX-WEISSEN-8 manufactured by NIPPON SEIRO CO., LTD.). The resultant toner was defined as Yellow Toner 32. Table 3 shows the physical properties of Yellow Toner 32.

### Comparative Example 4

A yellow toner was produced in the same manner as in Example 1 except that the wax component in Example 1 was changed to a hydrocarbon-based wax having a melting point of 55° C. (WEISSEN-T-0453 manufactured by NIPPON SEIRO CO., LTD.). The resultant toner was defined as Yellow Toner 33. Table 3 shows the physical properties of Yellow Toner 33.

### Comparative Example 5

Production was performed in the same manner as in Example 1 except that the wax component in Example 1 was changed to a hydrocarbon-based wax having a melting point of 105° C. (LUVAX-1151 manufactured by NIPPON SEIRO CO., LTD.). The resultant toner was defined as Yellow Toner 34. Table 3 shows the physical properties of Yellow Toner 34.

### Comparative Examples 6 to 15

Yellow toners were each produced in the same manner as in Example 1 except that the coloring compound D1 in Example 1 was changed to any one of the coloring compounds E1 to E7 and the coloring compounds E9 to E11. The resultant toners were defined as Yellow Toners 35 to 44. Table 3 shows the physical properties of Yellow Toners 35 to 44.

It should be noted that, when an attempt was made to produce toner particles by using the coloring compound E8 as a colorant instead of the coloring compound D1 under the same conditions as those described above, polymerization inhibition occurred, and no toner particles could be obtained.

TABLE 3

| | | | | | | | | | | | | Polymer |
|---|---|---|---|---|---|---|---|---|---|---|---|---|
| | | | | | | | | | | | | or copolymer |
| | | | Number- | | | | | | | | | having |
| | | | average | | | | | | Viscosity | | | sulfonic group, |
| | | | particle | Microscopic | | | | | at 100° C. | | Whether | sulfonate |
| | Yellow | Com- | diameter | compression | | | | | with flow | | pigment is | group, |
| | toner | pound | (d1) | test | | DSC | | | tester | Production | used in | or sulfonic acid |
| | No. | number | (μm) | Z (25) | Z (50) | P1 | TgA | P1 − TgA | (Pa · s) | method | combination | ester group |
| Example 1 | 1 | D1 | 6.8 | 55 | 25 | 77 | 45 | 32 | 8.0 × 10³ | Suspension | No | Present |
| | | | | | | | | | | polymerization | | |
| | | | | | | | | | | method | | |
| Example 2 | 2 | D2 | 7.1 | 54 | 26 | 77 | 44 | 33 | 7.5 × 10³ | Suspension | No | Present |
| | | | | | | | | | | polymerization | | |
| | | | | | | | | | | method | | |
| Example 3 | 3 | D3 | 7.9 | 53 | 27 | 76 | 45 | 31 | 7.6 × 10³ | Suspension | No | Present |
| | | | | | | | | | | polymerization | | |
| | | | | | | | | | | method | | |
| Example 4 | 4 | D4 | 5.5 | 55 | 25 | 75 | 46 | 29 | 7.8 × 10³ | Suspension | No | Present |
| | | | | | | | | | | polymerization | | |
| | | | | | | | | | | method | | |
| Example 5 | 5 | D5 | 6.6 | 51 | 28 | 74 | 45 | 29 | 7.9 × 10³ | Suspension | No | Present |
| | | | | | | | | | | polymerization | | |
| | | | | | | | | | | method | | |
| Example 6 | 6 | D6 | 6.8 | 52 | 29 | 77 | 44 | 33 | 7.6 × 10³ | Suspension | No | Present |
| | | | | | | | | | | polymerization | | |
| | | | | | | | | | | method | | |
| Example 7 | 7 | D7 | 6.4 | 55 | 30 | 78 | 45 | 33 | 7.7 × 10³ | Suspension | No | Present |
| | | | | | | | | | | polymerization | | |
| | | | | | | | | | | method | | |
| Example 8 | 8 | D8 | 6.9 | 53 | 25 | 77 | 45 | 32 | 8.2 × 10³ | Suspension | No | Present |
| | | | | | | | | | | polymerization | | |
| | | | | | | | | | | method | | |
| Example 9 | 9 | D9 | 7.2 | 55 | 27 | 75 | 44 | 31 | 7.9 × 10³ | Suspension | No | Present |
| | | | | | | | | | | polymerization | | |
| | | | | | | | | | | method | | |
| Example 10 | 10 | D10 | 7.0 | 56 | 26 | 78 | 46 | 32 | 7.5 × 10³ | Suspension | No | Present |
| | | | | | | | | | | polymerization | | |
| | | | | | | | | | | method | | |
| Example 11 | 11 | D11 | 6.6 | 51 | 26 | 77 | 46 | 31 | 7.7 × 10³ | Suspension | No | Present |
| | | | | | | | | | | polymerization | | |
| | | | | | | | | | | method | | |
| Example 12 | 12 | D12 | 6.8 | 52 | 27 | 76 | 45 | 31 | 8.2 × 10³ | Suspension | No | Present |
| | | | | | | | | | | polymerization | | |
| | | | | | | | | | | method | | |
| Example 13 | 13 | D13 | 7.1 | 55 | 25 | 74 | 45 | 29 | 7.7 × 10³ | Suspension | No | Present |
| | | | | | | | | | | polymerization | | |
| | | | | | | | | | | method | | |
| Example 14 | 14 | D14 | 7.8 | 55 | 28 | 75 | 46 | 29 | 7.5 × 10³ | Suspension | No | Present |
| | | | | | | | | | | polymerization | | |
| | | | | | | | | | | method | | |
| Example 15 | 15 | D15 | 6.3 | 51 | 25 | 76 | 44 | 32 | 7.9 × 10³ | Suspension | No | Present |
| | | | | | | | | | | polymerization | | |
| | | | | | | | | | | method | | |
| Example 16 | 16 | D16 | 6.6 | 53 | 25 | 74 | 44 | 30 | 8.0 × 10³ | Suspension | No | Present |
| | | | | | | | | | | polymerization | | |
| | | | | | | | | | | method | | |
| Example 17 | 17 | D1 | 7.7 | 45 | 19 | 74 | 40 | 34 | 4.2 × 10³ | Suspension | No | Present |
| | | | | | | | | | | polymerization | | |
| | | | | | | | | | | method | | |
| Example 18 | 18 | D1 | 6.0 | 54 | 25 | 75 | 45 | 30 | 8.1 × 10³ | Suspension | No | Absent |
| | | | | | | | | | | polymerization | | |
| | | | | | | | | | | method | | |
| Example 19 | 19 | D1 | 5.8 | 56 | 24 | 76 | 46 | 30 | 8.2 × 10³ | Suspension | No | Present |
| | | | | | | | | | | polymerization | | |
| | | | | | | | | | | method | | |
| Example 20 | 20 | D1 | 5.9 | 55 | 26 | 77 | 44 | 33 | 7.1 × 10³ | Suspension | No | Present |
| | | | | | | | | | | polymerization | | |
| | | | | | | | | | | method | | |
| Example 21 | 21 | D1 | 6.0 | 58 | 31 | 78 | 43 | 35 | 5.5 × 10³ | Suspension | No | Present |
| | | | | | | | | | | polymerization | | |
| | | | | | | | | | | method | | |
| Example 22 | 22 | D1 | 6.3 | 51 | 24 | 78 | 45 | 33 | 7.9 × 10³ | Suspension | No | Present |
| | | | | | | | | | | polymerization | | |
| | | | | | | | | | | method | | |
| Example 23 | 23 | D1 | 6.7 | 48 | 26 | 77 | 45 | 32 | 2.5 × 10³ | Suspension | No | Present |
| | | | | | | | | | | polymerization | | |
| | | | | | | | | | | method | | |
| Example 24 | 24 | D1 | 7.2 | 74 | 34 | 77 | 59 | 18 | 2.2 × 10⁴ | Suspension | No | Present |
| | | | | | | | | | | polymerization | | |
| | | | | | | | | | | method | | |
| Example 25 | 25 | D1 | 7.4 | 40 | 9 | 78 | 43 | 35 | 1.7 × 10⁴ | Suspension | No | Present |
| | | | | | | | | | | polymerization | | |
| | | | | | | | | | | method | | |
| Example 26 | 26 | D1 | 7.3 | 53 | 25 | 72 | 46 | 26 | 7.8 × 10³ | Suspension | Yes | Present |
| | | | | | | | | | | polymerization | | |
| | | | | | | | | | | method | | |
| Example 27 | 27 | D1 | 7.8 | 48 | 25 | 75 | 46 | 29 | 6.9 × 10³ | Emulsion | No | Present |
| | | | | | | | | | | polymerization | | |
| | | | | | | | | | | method | | |
| Example 28 | 28 | D1 | 6.4 | 48 | 25 | 76 | 45 | 31 | 9.9 × 10³ | Suspension | No | Absent |
| | | | | | | | | | | polymerization | | |
| | | | | | | | | | | method | | |
| Example 29 | 29 | D1 | 8.1 | 41 | 10 | 73 | 48 | 25 | 9.8 × 10³ | Pulverization | No | Present |
| | | | | | | | | | | method | | |
| Comparative | 30 | D1 | 6.6 | 85 | 39 | 77 | 45 | 32 | 6.0 × 10⁴ | Suspension | No | Present |
| Example 1 | | | | | | | | | | polymerization | | |
| | | | | | | | | | | method | | |
| Comparative | 31 | D1 | 6.8 | 42 | 12 | 77 | 30 | 47 | 2.0 × 10³ | Suspension | No | Present |
| Example 2 | | | | | | | | | | polymerization | | |
| | | | | | | | | | | method | | |
| Comparative | 32 | D1 | 7.0 | 78 | 37 | 86 | 68 | 18 | 5.3 × 10⁴ | Suspension | No | Present |
| Example 3 | | | | | | | | | | polymerization | | |
| | | | | | | | | | | method | | |
| Comparative | 33 | D1 | 7.2 | 55 | 28 | 55 | 42 | 13 | 3.1 × 10³ | Suspension | No | Present |
| Example 4 | | | | | | | | | | polymerization | | |
| | | | | | | | | | | method | | |
| Comparative | 34 | D1 | 6.0 | 59 | 22 | 105 | 45 | 60 | 3.2 × 10³ | Suspension | No | Present |
| Example 5 | | | | | | | | | | polymerization | | |
| | | | | | | | | | | method | | |
| Comparative | 35 | E1 | 6.9 | 55 | 25 | 77 | 45 | 32 | 8.3 × 10³ | Suspension | No | Present |
| Example 6 | | | | | | | | | | polymerization | | |
| | | | | | | | | | | method | | |
| Comparative | 36 | E2 | 7.3 | 55 | 26 | 77 | 46 | 31 | 7.9 × 10³ | Suspension | No | Present |
| Example 7 | | | | | | | | | | polymerization | | |
| | | | | | | | | | | method | | |
| Comparative | 37 | E3 | 6.9 | 54 | 25 | 77 | 45 | 32 | 7.7 × 10³ | Suspension | No | Present |
| Example 8 | | | | | | | | | | polymerization | | |
| | | | | | | | | | | method | | |
| Comparative | 38 | E4 | 6.1 | 56 | 24 | 77 | 48 | 29 | 7.4 × 10³ | Suspension | No | Present |
| Example 9 | | | | | | | | | | polymerization | | |
| | | | | | | | | | | method | | |
| Comparative | 39 | E5 | 6.8 | 55 | 23 | 78 | 46 | 32 | 7.9 × 10³ | Suspension | No | Present |
| Example 10 | | | | | | | | | | polymerization | | |
| | | | | | | | | | | method | | |
| Comparative | 40 | E6 | 6.9 | 58 | 25 | 77 | 44 | 33 | 8.8 × 10³ | Suspension | No | Present |
| Example 11 | | | | | | | | | | polymerization | | |
| | | | | | | | | | | method | | |
| Comparative | 41 | E7 | 7.4 | 50 | 26 | 77 | 42 | 35 | 8.9 × 10³ | Suspension | No | Present |
| Example 12 | | | | | | | | | | polymerization | | |
| | | | | | | | | | | method | | |
| Comparative | 42 | E9 | 6.1 | 54 | 27 | 77 | 44 | 33 | 7.5 × 10³ | Suspension | No | Present |
| Example 13 | | | | | | | | | | polymerization | | |
| | | | | | | | | | | method | | |
| Comparative | 43 | E10 | 5.8 | 56 | 24 | 76 | 45 | 31 | 7.7 × 10³ | Suspension | No | Present |
| Example 14 | | | | | | | | | | polymerization | | |
| | | | | | | | | | | method | | |
| Comparative | 44 | E11 | 6.0 | 57 | 24 | 76 | 46 | 30 | 8.2 × 10³ | Suspension | No | Present |
| Example 15 | | | | | | | | | | polymerization | | |
| | | | | | | | | | | method | | |

(Evaluation of Yellow Toner)

Evaluation methods and evaluation criteria adopted in the present invention will be described below.

A developing device of an LBP5400 (manufactured by Canon Inc.) was filled with 150 g of any one of the yellow toners produced in the above examples and comparative examples (see Table 4), and then evaluation was performed. It should be noted that the LBP was reconstructed so as to be capable of outputting a monochrome, and an image output from the modified apparatus was evaluated.

In the evaluation, the evaluating machine, i.e., the modified apparatus was subjected to density detection correction, and continuous output was performed on a chart having a print percentage of 1%. The following image evaluations were performed under each environment when the total number of sheets on which images had been output reached 20,000 (Xerox 4024, letter size, 75-g/m2 paper, manufactured by XEROX CORPORATION). To be specific, the evaluations were performed under each of a high-temperature, high-humidity environment (30° C., 80 RH %), a normal-temperature, normal-humidity environment (20° C., 60 RH %), and a low-temperature, low-humidity environment (10° C., 20 RH %).

(1) Evaluation for Developing Performance

(a) Percentage by which Image Density Reduced

At the time of the completion of 20,000-sheet output duration evaluation, entirely solid images (each having a toner laid-on level of 0.55 mg/cm²) were output on ten sheets, and the percentage by which the image density of the 20,010-th sheet reduced as compared to that of the 20,001-st sheet was measured. Each image density was a density measured relative to an image at a white portion having an original density of zero with a “Macbeth reflection densitometer RD918” (manufactured by Macbeth Co.).

(Percentage by which density reduced)={(image density of 20,001-st sheet−image density of 20,010-th sheet)/(image density of 20,001-st sheet)}×100

A: The percentage by which the density reduced is less than 3%, which is at such a level that no problems arise in practical use.

B: The percentage by which the density reduced is 3% or more and less than 7%.

C: The percentage by which the density reduced is 7% or more and less than 10%.

D: The percentage by which the density reduced is 10% or more.

(b) Fogging

An evaluation method is as described below. An image having a white portion was output, and its degree of whiteness was measured with a “REFLECTMETER MODEL TC-6DS” (manufactured by Tokyo Denshoku CO., LTD.). A fogging density (%) (=Dr (%)−Ds (%)) was calculated from a difference between the degree of whiteness (reflectance Ds (%)) of the white portion of the output image and the degree of whiteness (average reflectance Dr (%)) of transfer paper, and evaluation for image fogging at the time of the completion of the 20,000-sheet output duration evaluation was performed. A green light filter was used as a filter.

A: Less than 0.5%.

B: 0.5% or more and less than 1.0%.

C: 1.0% or more and less than 3.0%.

D: 3.0% or more.

(c) Fine-Line Reproducibility

At the time of the completion of the 20,000-sheet output duration evaluation, a character pattern corresponding to a specific character “kyo (meaning “surprise” in Japanese)” was output on A4-size cardboard (128 g/m2). The output pattern was evaluated for the presence or absence of voids in its character portion by visual observation.

A: No voids occur.

B: Nearly no voids occur.

C: Slight voids are observed.

D: Remarkable voids are observed.

(d) Dot Reproducibility

At the time of the completion of the 20,000-sheet output duration evaluation, the main body of the apparatus was forcedly powered off during the output of an entirely halftone image (having a toner laid-on level of 0.20 mg/cm2) on one sheet. Then, the reproducibility of developed dots on a photosensitive drum was observed. Evaluation was performed while the drum was visually observed with an optical microscope at a magnification of 100. Judgement criteria are described below.

A: The dot reproducibility is good.

B: The dot reproducibility is slightly disturbed.

C: The dot reproducibility is disturbed.

D: The dot reproducibility is remarkably disturbed.

(2) Evaluation for Adhesion to Member

(a) Contamination of Toner Carrying Member

Circumferential streaks of a toner carrying member and toner scattering were observed as described below. At the time of the completion of the above 20,000-sheet output duration evaluation, an entirely solid image (having a toner laid-on level of 0.55 mg/cm2) was output on one sheet. After that, the developer container was disassembled, and the surface and edge of the toner carrying member were visually observed. Judgement criteria are described below.

A: Level at which the surface and edge of the toner carrying member are completely free of filming, a circumferential streak, or the like due to the breakage of the toner or the adhesion of the coloring compound.

B: Level at which filming or the like due to the breakage of the toner or the adhesion of the coloring compound slightly occurs at the surface or edge of the toner carrying member.

C: Level at which five to ten circumferential streaks due to the breakage of the toner or the adhesion of the coloring compound are observed at the edge of the toner carrying member.

D: Level at which the melt adhesion of the toner in the circumferential direction on the surface of the toner carrying member occurs and the edge of the carrying member is shaved so that the toner may leak.

(b) Contamination of Control Member

Judgment as to whether a control member was contaminated was made as described below. At the time of the completion of the above 20,000-sheet output duration evaluation, an entirely halftone image (having a toner laid-on level of 0.20 mg/cm²) was output on one sheet. After that, the developer container was disassembled, and the control member was visually observed. An arbitrary square region 2 cm on a side on the halftone image was evaluated for the presence or absence of the generation of fine vertical streaks by visual observation. Judgement criteria are described below.

A: No product as a result of the melt adhesion of the toner is present on the control member, and no streaks are present on the image.

B: A trace amount of a product as a result of the melt adhesion of the toner is present on the control member, and one to four streaks are present on the image.

C: A product as a result of the melt adhesion of the toner is present on the control member, and five to nine streaks are present on the image.

D: A product as a result of the melt adhesion of the toner is present on the control member, and ten or more streaks are present on the image.

(3) Evaluation for Transferring Performance

At the time of the completion of the 20,000-sheet output duration evaluation, each of an entirely halftone image (having a toner laid-on level of 0.20 mg/cm2) and an entirely solid image (having a toner laid-on level of 0.55 mg/cm2) was output on one sheet, and was evaluated for transferring performance. Judgement criteria are described below.

A: Level at which each of the halftone image and the solid image is excellent in uniformity in one page.

B: Level at which the halftone image is slightly poor in uniformity in one page.

C: Level at which each of the halftone image and the solid image is slightly poor in uniformity in one page.

D: Level at which each of the halftone image and the solid image is poor in uniformity in one page.

(4) Evaluation for Fixing Performance

At the time of the completion of the 20,000-sheet output duration evaluation, the machine and the cartridge filled with the toner were left to stand under each environment for 24 hours. After that, a 200 μm-wide horizontal line pattern (breadth 200 μm, interval 100 μm) was output on one sheet with the evaluating machine, and the output image was used in evaluation for fixing performance. The evaluation for fixing performance was performed as described below. The image was reciprocally rubbed with lens-cleaning paper at a load of 100 g five times, and the image was evaluated for its peeling on the basis of the average percentage (%) by which a reflection density reduced.

The reflection density was measured with a “Macbeth reflection densitometer RD918” (manufactured by Macbeth Co.). Bond paper having a surface smoothness of 10 [sec] or less was used in the evaluation. Evaluation criteria are described below.

A: The percentage by which the density reduced is less than 5%.

B: The percentage by which the density reduced is 5% or more and less than 10%.

C: The percentage by which the density reduced is 10% or more.

D: A fixation failure occurs in the evaluation image before the rubbing with lens-cleaning paper.

(5) Evaluation for Light Fastness

At the time of the completion of the 20,000-sheet output duration evaluation, solid images each having a toner laid-on level of 0.6 to 0.7 mg/cm² were produced on ten sheets, and were each evaluated for light fastness with a UV automatic fade meter “FAL-AU” (manufactured by SUGA TEST INSTRUMENTS CO., LTD.) using a carbon arc lamp as a light source in conformance with “JIS K 7102”. The maximum irradiation time was set to 80 hours, and each image was evaluated for light fastness by calculating a maintenance ratio of the density of the image after irradiation with light to that before the irradiation. As the image density maintenance ratio (%) approaches 100%, the image is more excellent in light fastness.

A: 95% or more.

B: 90% or more and less than 95%.

C: 80% or more and less than 90%.

D: Less than 80%.

(6) Evaluation for Paper-OHT Hue Difference

Evaluation for paper-OHT hue difference was performed as described below.

Color space measurement for transmitted light was performed as described below. An image obtained at the time of the completion of the 20,000-sheet output duration evaluation was turned into a transparent image with an overhead projector (OHP: 9550 manufactured by 3M). The hue angle of an image obtained by projecting the transparent image onto a white wall surface was measured with a spectral radiance meter (PR650 manufactured by Photo Research, Inc.).

Then, an angle difference Δh* between the hue angle h*(OHP) of the image projected onto the white wall surface and a hue angle h*(paper) of the solid portion on paper was evaluated on the basis of four stages defined as described below.

A: Δh*≦5

B: 5<Δh*≦10

C: 10<Δh*≦15

D: Δh*>15

### Evaluation Test Examples 1 to 16

Yellow Toners 1 to 16 were each subjected to the above evaluations. As a result, each of the toners showed good results for the respective items. Table 4 shows the results of the evaluations.

### Evaluation Test Examples 17 to 29

Yellow Toners 17 to 29 were each subjected to the above evaluations. As a result, each of the toners showed results at such levels as to be usable without any problem. Table 4 shows the results of the evaluations.

### Comparative Evaluation Test Example 1

Yellow Toner 30 was subjected to the above evaluations. The toner showed remarkably bad results for the respective items. This is probably because the Z(25) and Z(50) of the toner were large, and the toner had a high viscosity at 100° C. Table 4 shows the results of the evaluations.

### Comparative Evaluation Test Example 2

Yellow Toner 31 was subjected to the above evaluations. The toner showed remarkably bad results for the respective items. This is probably because the TgA of the toner was low, and the toner had a low viscosity at 100° C. Table 4 shows the results of the evaluations.

### Comparative Evaluation Test Example 3

Yellow Toner 32 was subjected to the above evaluations. The toner showed remarkably bad results for the respective items. This is probably because the TgA of the toner was high, and the toner had a high viscosity at 100° C. Table 4 shows the results of the evaluations.

### Comparative Evaluation Test Example 4

Yellow Toner 33 was subjected to the above evaluations. The toner showed remarkably bad results for the respective items. This is probably because P1 and (P1−TgA) was low. Table 4 shows the results of the evaluations.

### Comparative Evaluation Test Example 5

Yellow Toner 34 was subjected to the above evaluations. The toner showed remarkably bad results for the respective items. This is probably because P1 and (P1−TgA) was high. Table 4 shows the results of the evaluations.

### Comparative Evaluation Test Examples 6 to 15

Yellow Toners 35 to 44 were each subjected to the above evaluations. Each of the toners showed remarkably bad results for the respective items. This is probably because any one of the coloring compounds E1 to E7 and the coloring compounds E9 to E11 was used as a colorant. Table 4 shows the results of the evaluations.

TABLE 4

| | | Percentage by which image | | | | | | Fine-line | | | | | | Contamination of toner | | |
|---|---|---|---|---|---|---|---|---|---|---|---|---|---|---|---|---|
| | | density reduced | | | Fogging | | | reproducibility | | | Dot reproducibility | | | carrying member | | |
| | | High | Normal | Low | High | Normal | Low | High | Normal | Low | High | Normal | Low | High | Normal | |
| | | temper- | temper- | temper- | temper- | temper- | temper- | temper- | temper- | temper- | temper- | temper- | temper- | temper- | temper- | Low |
| | | ature, | ature, | ature, | ature, | ature, | ature, | ature, | ature, | ature, | ature, | ature, | ature, | ature, | ature, | temperature, |
| | | high | normal | low | high | normal | low | high | normal | low | high | normal | low | high | normal | low |
| | Toner No. | humidity | humidity | humidity | humidity | humidity | humidity | humidity | humidity | humidity | humidity | humidity | humidity | humidity | humidity | humidity |
| Evaluation Test | 1 | A | A | A | A | A | A | A | A | A | A | A | A | A | A | A |
| Example 1 | | | | | | | | | | | | | | | | |
| Evaluation Test | 2 | A | A | A | A | A | A | A | A | A | A | A | A | A | A | A |
| Example 2 | | | | | | | | | | | | | | | | |
| Evaluation Test | 3 | A | A | A | A | A | A | A | A | A | A | A | A | A | A | A |
| Example 3 | | | | | | | | | | | | | | | | |
| Evaluation Test | 4 | A | A | A | A | A | A | A | A | A | A | A | A | A | A | A |
| Example 4 | | | | | | | | | | | | | | | | |
| Evaluation Test | 5 | A | A | A | A | A | A | A | A | A | A | A | A | A | A | A |
| Example 5 | | | | | | | | | | | | | | | | |
| Evaluation Test | 6 | A | A | A | A | A | A | A | A | A | A | A | A | A | A | B |
| Example 6 | | | | | | | | | | | | | | | | |
| Evaluation Test | 7 | A | A | A | A | A | A | A | A | A | A | A | A | A | A | A |
| Example 7 | | | | | | | | | | | | | | | | |
| Evaluation Test | 8 | A | A | A | A | A | A | A | A | A | A | A | A | A | A | A |
| Example 8 | | | | | | | | | | | | | | | | |
| Evaluation Test | 9 | A | A | A | A | A | A | A | A | A | A | A | A | A | A | A |
| Example 9 | | | | | | | | | | | | | | | | |
| Evaluation Test | 10 | A | A | A | A | A | A | A | A | A | A | A | A | A | A | A |
| Example 10 | | | | | | | | | | | | | | | | |
| Evaluation Test | 11 | A | A | A | A | A | A | A | A | A | A | A | A | A | A | A |
| Example 11 | | | | | | | | | | | | | | | | |
| Evaluation Test | 12 | A | A | A | A | A | A | A | A | A | A | A | A | A | A | A |
| Example 12 | | | | | | | | | | | | | | | | |
| Evaluation Test | 13 | A | A | A | A | A | A | A | A | A | A | A | A | A | A | A |
| Example 13 | | | | | | | | | | | | | | | | |
| Evaluation Test | 14 | A | A | A | A | A | A | A | A | A | A | A | A | A | A | A |
| Example 14 | | | | | | | | | | | | | | | | |
| Evaluation Test | 15 | A | A | A | A | A | A | A | A | A | A | A | A | B | A | A |
| Example 15 | | | | | | | | | | | | | | | | |
| Evaluation Test | 16 | A | A | A | A | A | A | A | A | A | A | A | A | B | A | A |
| Example 16 | | | | | | | | | | | | | | | | |
| Evaluation Test | 17 | B | A | A | B | A | A | A | B | A | A | A | A | A | A | A |
| Example 17 | | | | | | | | | | | | | | | | |
| Evaluation Test | 18 | B | A | A | B | A | A | A | B | A | A | A | B | A | A | B |
| Example 18 | | | | | | | | | | | | | | | | |
| Evaluation Test | 19 | B | A | A | B | A | A | A | A | A | A | A | B | A | A | B |
| Example 19 | | | | | | | | | | | | | | | | |
| Evaluation Test | 20 | B | A | B | B | A | B | A | A | A | A | B | B | A | B | B |
| Example 20 | | | | | | | | | | | | | | | | |
| Evaluation Test | 21 | A | B | B | B | A | A | A | A | A | A | B | B | A | B | B |
| Example 21 | | | | | | | | | | | | | | | | |
| Evaluation Test | 22 | A | B | B | B | A | B | A | B | A | A | B | B | A | B | B |
| Example 22 | | | | | | | | | | | | | | | | |
| Evaluation Test | 23 | A | B | B | B | A | B | A | B | A | A | B | B | A | B | B |
| Example 23 | | | | | | | | | | | | | | | | |
| Evaluation Test | 24 | B | B | B | B | B | A | A | A | A | A | B | B | A | B | B |
| Example 24 | | | | | | | | | | | | | | | | |
| Evaluation Test | 25 | B | B | B | B | B | B | A | B | A | A | B | B | A | B | B |
| Example 25 | | | | | | | | | | | | | | | | |
| Evaluation Test | 26 | A | B | A | A | B | B | A | A | A | A | A | A | A | A | A |
| Example 26 | | | | | | | | | | | | | | | | |
| Evaluation Test | 27 | A | B | A | B | B | B | A | A | A | A | A | A | A | B | A |
| Example 27 | | | | | | | | | | | | | | | | |
| Evaluation Test | 28 | A | B | B | B | A | B | A | A | B | B | A | B | B | B | A |
| Example 28 | | | | | | | | | | | | | | | | |
| Evaluation Test | 29 | B | A | A | A | A | B | B | B | B | B | B | B | A | A | B |
| Example 29 | | | | | | | | | | | | | | | | |
| Comparative | 30 | C | B | B | C | B | C | C | B | B | B | B | B | B | B | B |
| Evaluation Test | | | | | | | | | | | | | | | | |
| Example 1 | | | | | | | | | | | | | | | | |
| Comparative | 31 | C | B | C | C | C | C | C | B | C | C | B | B | C | B | B |
| Evaluation Test | | | | | | | | | | | | | | | | |
| Example 2 | | | | | | | | | | | | | | | | |
| Comparative | 32 | B | B | C | C | B | C | B | C | C | C | B | B | C | B | B |
| Evaluation Test | | | | | | | | | | | | | | | | |
| Example 3 | | | | | | | | | | | | | | | | |
| Comparative | 33 | B | B | C | B | B | C | B | B | B | B | B | B | B | B | B |
| Evaluation Test | | | | | | | | | | | | | | | | |
| Example 4 | | | | | | | | | | | | | | | | |
| Comparative | 34 | C | B | C | B | B | C | B | B | B | B | B | B | B | B | B |
| Evaluation Test | | | | | | | | | | | | | | | | |
| Example 5 | | | | | | | | | | | | | | | | |
| Comparative | 35 | C | C | C | B | C | C | C | B | B | B | B | C | B | B | C |
| Evaluation Test | | | | | | | | | | | | | | | | |
| Example 6 | | | | | | | | | | | | | | | | |
| Comparative | 36 | C | B | C | B | C | C | C | C | B | B | B | C | D | B | C |
| Evaluation Test | | | | | | | | | | | | | | | | |
| Example 7 | | | | | | | | | | | | | | | | |
| Comparative | 37 | D | D | C | B | C | C | B | B | C | D | B | C | D | B | C |
| Evaluation Test | | | | | | | | | | | | | | | | |
| Example 8 | | | | | | | | | | | | | | | | |
| Comparative | 38 | C | B | C | D | C | C | D | C | B | D | D | C | D | B | C |
| Evaluation Test | | | | | | | | | | | | | | | | |
| Example 9 | | | | | | | | | | | | | | | | |
| Comparative | 39 | D | D | C | B | C | C | D | C | C | D | D | C | D | B | C |
| Evaluation Test | | | | | | | | | | | | | | | | |
| Example 10 | | | | | | | | | | | | | | | | |
| Comparative | 40 | C | D | C | D | C | C | D | C | B | D | D | C | D | B | C |
| Evaluation Test | | | | | | | | | | | | | | | | |
| Example 11 | | | | | | | | | | | | | | | | |
| Comparative | 41 | C | B | C | B | C | C | D | C | D | D | D | C | D | B | C |
| Evaluation Test | | | | | | | | | | | | | | | | |
| Example 12 | | | | | | | | | | | | | | | | |
| Comparative | 42 | D | D | C | B | C | C | D | C | C | D | D | C | D | B | C |
| Evaluation Test | | | | | | | | | | | | | | | | |
| Example 13 | | | | | | | | | | | | | | | | |
| Comparative | 43 | C | D | C | D | C | C | D | C | B | D | D | C | D | B | C |
| Evaluation Test | | | | | | | | | | | | | | | | |
| Example 14 | | | | | | | | | | | | | | | | |
| Comparative | 44 | C | B | C | B | C | C | D | C | D | D | D | C | D | B | C |
| Evaluation Test | | | | | | | | | | | | | | | | |
| Example 15 | | | | | | | | | | | | | | | | |

| | | | | | | | | | | | | | | Paper-OHT |
|---|---|---|---|---|---|---|---|---|---|---|---|---|---|---|
| | | Contamination of control | | | | | | | | | | | | hue |
| | | member | | | Transferring performance | | | Fixing performance | | | Light fastness | | | difference |
| | | High | Normal | Low | High | Normal | Low | High | Normal | Low | High | Normal | Low | Normal |
| | | temperature, | temperature, | temperature, | temperature, | temperature, | temperature, | temperature, | temperature, | temperature, | temperature, | temperature, | temperature, | temperature, |
| | Toner | high | normal | low | high | normal | low | high | normal | low | high | normal | low | normal |
| | No. | humidity | humidity | humidity | humidity | humidity | humidity | humidity | humidity | humidity | humidity | humidity | humidity | humidity |
| Evaluation Test | 1 | A | A | A | A | A | A | A | A | A | A | A | A | A |
| Example 1 | | | | | | | | | | | | | | |
| Evaluation Test | 2 | A | A | A | A | A | A | A | A | A | A | A | A | A |
| Example 2 | | | | | | | | | | | | | | |
| Evaluation Test | 3 | A | A | A | A | A | A | A | A | A | A | A | A | A |
| Example 3 | | | | | | | | | | | | | | |
| Evaluation Test | 4 | A | A | A | A | A | A | A | A | A | A | A | A | A |
| Example 4 | | | | | | | | | | | | | | |
| Evaluation Test | 5 | A | A | A | A | A | A | A | A | A | A | A | A | A |
| Example 5 | | | | | | | | | | | | | | |
| Evaluation Test | 6 | A | A | A | A | A | A | A | A | A | A | A | A | A |
| Example 6 | | | | | | | | | | | | | | |
| Evaluation Test | 7 | A | A | A | A | A | A | A | A | A | A | A | A | A |
| Example 7 | | | | | | | | | | | | | | |
| Evaluation Test | 8 | A | A | A | A | A | A | A | A | A | A | A | B | A |
| Example 8 | | | | | | | | | | | | | | |
| Evaluation Test | 9 | A | A | A | A | A | A | A | A | A | A | A | B | A |
| Example 9 | | | | | | | | | | | | | | |
| Evaluation Test | 10 | A | A | A | A | A | A | A | A | A | A | A | A | B |
| Example 10 | | | | | | | | | | | | | | |
| Evaluation Test | 11 | A | A | A | A | A | A | A | A | A | B | A | A | A |
| Example 11 | | | | | | | | | | | | | | |
| Evaluation Test | 12 | A | A | B | A | A | A | A | A | A | A | A | A | A |
| Example 12 | | | | | | | | | | | | | | |
| Evaluation Test | 13 | B | A | A | A | A | A | A | A | A | A | A | A | A |
| Example 13 | | | | | | | | | | | | | | |
| Evaluation Test | 14 | A | A | A | A | A | A | A | A | A | A | A | A | A |
| Example 14 | | | | | | | | | | | | | | |
| Evaluation Test | 15 | A | A | A | A | A | A | A | A | A | A | A | A | A |
| Example 15 | | | | | | | | | | | | | | |
| Evaluation Test | 16 | B | A | A | A | A | A | A | A | A | A | A | A | A |
| Example 16 | | | | | | | | | | | | | | |
| Evaluation Test | 17 | A | A | B | A | B | B | A | A | B | A | A | B | A |
| Example 17 | | | | | | | | | | | | | | |
| Evaluation Test | 18 | A | A | B | B | A | B | A | A | B | A | A | B | A |
| Example 18 | | | | | | | | | | | | | | |
| Evaluation Test | 19 | A | B | B | B | A | B | B | A | B | B | A | B | B |
| Example 19 | | | | | | | | | | | | | | |
| Evaluation Test | 20 | A | A | B | B | A | B | A | A | B | A | A | B | A |
| Example 20 | | | | | | | | | | | | | | |
| Evaluation Test | 21 | A | B | B | B | A | B | B | A | B | B | A | B | B |
| Example 21 | | | | | | | | | | | | | | |
| Evaluation Test | 22 | A | B | B | A | A | B | B | A | B | B | A | B | B |
| Example 22 | | | | | | | | | | | | | | |
| Evaluation Test | 23 | A | B | B | A | B | B | B | A | B | B | A | B | B |
| Example 23 | | | | | | | | | | | | | | |
| Evaluation Test | 24 | A | B | B | A | B | B | B | A | B | B | A | B | B |
| Example 24 | | | | | | | | | | | | | | |
| Evaluation Test | 25 | A | B | B | A | B | B | B | A | B | B | A | B | B |
| Example 25 | | | | | | | | | | | | | | |
| Evaluation Test | 26 | A | A | A | A | A | A | A | A | A | A | A | A | A |
| Example 26 | | | | | | | | | | | | | | |
| Evaluation Test | 27 | A | B | B | B | B | A | A | A | B | A | A | B | A |
| Example 27 | | | | | | | | | | | | | | |
| Evaluation Test | 28 | A | B | B | B | B | A | A | A | A | A | A | A | A |
| Example 28 | | | | | | | | | | | | | | |
| Evaluation Test | 29 | A | B | B | B | B | B | A | A | A | A | A | A | A |
| Example 29 | | | | | | | | | | | | | | |
| Comparative | 30 | B | B | B | B | B | B | B | B | B | B | B | B | B |
| Evaluation Test | | | | | | | | | | | | | | |
| Example 1 | | | | | | | | | | | | | | |
| Comparative | 31 | C | B | B | B | B | B | B | B | B | B | B | B | B |
| Evaluation Test | | | | | | | | | | | | | | |
| Example 2 | | | | | | | | | | | | | | |
| Comparative | 32 | C | B | C | B | B | B | B | B | B | B | B | B | B |
| Evaluation Test | | | | | | | | | | | | | | |
| Example 3 | | | | | | | | | | | | | | |
| Comparative | 33 | C | B | B | B | B | C | B | B | B | B | B | B | B |
| Evaluation Test | | | | | | | | | | | | | | |
| Example 4 | | | | | | | | | | | | | | |
| Comparative | 34 | C | B | B | C | B | C | B | B | B | B | B | B | B |
| Evaluation Test | | | | | | | | | | | | | | |
| Example 5 | | | | | | | | | | | | | | |
| Comparative | 35 | C | B | B | B | D | C | B | C | B | B | C | B | C |
| Evaluation Test | | | | | | | | | | | | | | |
| Example 6 | | | | | | | | | | | | | | |
| Comparative | 36 | C | D | B | D | B | C | B | D | C | B | C | C | C |
| Evaluation Test | | | | | | | | | | | | | | |
| Example 7 | | | | | | | | | | | | | | |
| Comparative | 37 | C | B | B | B | B | C | B | B | C | B | B | C | C |
| Evaluation Test | | | | | | | | | | | | | | |
| Example 8 | | | | | | | | | | | | | | |
| Comparative | 38 | C | D | D | B | B | C | B | B | C | C | B | C | D |
| Evaluation Test | | | | | | | | | | | | | | |
| Example 9 | | | | | | | | | | | | | | |
| Comparative | 39 | C | D | D | B | B | C | D | D | D | D | D | C | D |
| Evaluation Test | | | | | | | | | | | | | | |
| Example 10 | | | | | | | | | | | | | | |
| Comparative | 40 | C | D | D | B | B | C | D | D | D | D | D | C | D |
| Evaluation Test | | | | | | | | | | | | | | |
| Example 11 | | | | | | | | | | | | | | |
| Comparative | 41 | C | D | D | B | B | C | D | D | C | D | C | C | D |
| Evaluation Test | | | | | | | | | | | | | | |
| Example 12 | | | | | | | | | | | | | | |
| Comparative | 42 | C | D | D | B | B | C | D | D | D | D | D | C | D |
| Evaluation Test | | | | | | | | | | | | | | |
| Example 13 | | | | | | | | | | | | | | |
| Comparative | 43 | C | D | D | B | B | C | D | D | C | D | C | C | D |
| Evaluation Test | | | | | | | | | | | | | | |
| Example 14 | | | | | | | | | | | | | | |
| Comparative | 44 | C | D | D | B | B | C | D | D | D | D | D | C | D |
| Evaluation Test | | | | | | | | | | | | | | |
| Example 15 | | | | | | | | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-003231, filed Jan. 10, 2008 which is hereby incorporated by reference herein in its entirety.

What is claimed is:

1. A yellow toner comprising toner particles each containing at least a binder resin, a colorant, and a polar resin, the yellow toner being characterized in that:
the colorant comprises a coloring compound having a structure represented by the following formula (1): 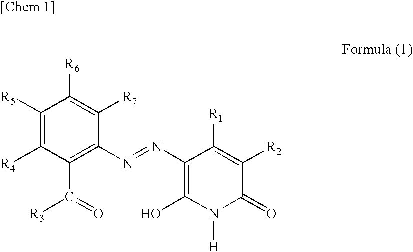
where R₁ represents an alkyl group or an aryl group, R₂ represents a hydrogen atom, a cyano group, or —CONH₂, R₃ represents an alkyloxy group, an alkenyloxy group, an aryloxy group, an aralkyloxy group, or —NR₈R₉ where R₈ and R₉ each independently represent a hydrogen atom, an alkyl group, an aryl group, an alkenyl group, or an aralkyl group, and —NR₈R₉ may form a heterocyclic ring, and R₄, R₅, R₆, and R₇ each independently represent a hydrogen atom, a halogen atom, —CF₃, —NO₂, an alkyl group, or an alkyloxy group;
wherein, in a microscopic compression test on the toner at a measurement temperature of 25° C., a displacement (μm) at a time point when one particle of the toner is left to stand for 0.1 second after completion of application of a maximum load of 2.94×10⁻⁴ N to the particle at a loading rate of 9.8×10⁻⁵ N/sec is defined as a maximum displacement X₃₍₂₅₎, and a displacement (μm) at a time point when the load is unloaded at an unloading rate of 9.8×10⁻⁵ N/sec to reach 0 N after the standing for 0.1 second is defined as a displacement X₄₍₂₅₎, a recovery ratio Z(25) (%) [={(X₃₍₂₅₎−X₄₍₂₅₎)/X₃₍₂₅₎}×100] as a percentage of an elastic displacement (X₃₍₂₅₎−X₄₍₂₅₎) as a difference between the maximum displacement X₃₍₂₅₎ and the displacement X₄₍₂₅₎ to the maximum displacement X₃₍₂₅₎ satisfies a relationship of 40≦Z(25)≦80; and
the toner has a glass transition temperature (TgA) measured with a differential scanning calorimeter (DSC) of 40° C. to 60° C. and a temperature (P1) of a highest endothermic peak measured with the DSC of 70° C. to 90° C., and the temperature (P1) of the highest endothermic peak and the glass transition temperature (TgA) satisfy a relationship of 15° C.≦P1−TgA≦50° C.

2. A yellow toner according to claim 1, characterized in that the colorant comprises a coloring compound represented by the formula (1) in which R₃ represents —NR₈R₉ where R₈ and R₉ each independently represent an alkyl group.

3. A yellow toner according to claim 1, characterized in that the colorant comprises a coloring compound represented by the formula (1) in which R₁ represents a methyl group or a phenyl group.

4. A yellow toner according to claim 1, characterized in that the colorant comprises a coloring compound represented by the formula (1) in which R₂ represents a cyano group.

5. A yellow toner according to claim 1, characterized in that, in a case where, in a microscopic compression test on the toner at a measurement temperature of 50° C., a displacement (μm) at a time point when one particle of the toner is left to stand for 0.1 second after completion of application of a maximum load of 2.94×10⁻⁴ N to the particle at a loading rate of 9.8×10⁻⁵ N/sec is defined as a maximum displacement X₃₍₅₀₎, and a displacement (μm) at a time point when the load is unloaded at an unloading rate of 9.8×10⁻⁵ N/sec to reach 0 N after the standing for 0.1 second is defined as a displacement X₄₍₅₀₎, a recovery ratio Z(50) (%) [={(X₃₍₅₀₎−X₄₍₅₀₎)/X₃₍₅₀₎}×100] as a percentage of an elastic displacement (X₃₍₅₀₎−X₄₍₅₀₎) as a difference between the maximum displacement X₃₍₅₀₎ and the displacement X₄₍₅₀₎ to the maximum displacement X₃₍₅₀₎ satisfies a relationship of 10≦Z(50)≦35.

6. A yellow toner according to claim 1, characterized in that the toner has a viscosity at 100° C. by a flow tester heating method of 3.0×10³ Pa·s to 2.0×10⁴ Pa·s.

7. A yellow toner according to claim 1, characterized in that the toner particles comprise toner particles produced by
dispersing, in an aqueous medium, a polymerizable monomer composition containing at least a polymerizable monomer, the colorant, and the polar resin,
granulating the resultant, and
polymerizing the polymerizable monomer in the polymerizable monomer composition.

8. A yellow toner according to claim 1, characterized in that the colorant further contains a yellow pigment.

9. A yellow toner according to claim 1, characterized in that the toner particles each contain a polymer having a sulfonic group, a sulfonate group, or a sulfonic acid ester group.
